(19) United States
(12) Patent Application Publication
(10) Pub. No.: US 2025/0122023 A1
(43) Pub. Date: Apr. 17, 2025

(54) METHODS, DEVICES, AND SYSTEMS FOR FACILITATING MOVEMENT OF MATERIAL

(71) Applicant: TECK RESOURCES LIMITED, Vancouver (CA)

(72) Inventors: Daniel Levi MYCK, Fernie (CA); Esaias Engelbertus SCHALEKAMP, Elkford (CA); Keith Edward MAYHEW, Delta (CA); Felipe Camilo e Silva MARTINS, Vancouver (CA); Ben DANIC, Fernie (CA); Nicola BORN, Coleman (CA)

(73) Assignee: TECK RESOURCES LIMITED, Vancouver, BC (CA)

(21) Appl. No.: 18/723,306

(22) PCT Filed: Dec. 22, 2022
(86) PCT No.: PCT/CA2022/051891

§ 371 Date: Jun. 21, 2024

Related U.S. Application Data
(60) Provisional application No. 63/293,308, filed on Dec. 23, 2021.

(51) Int. Cl. B65G 43/08; B65G 3/04

(52) U.S. Cl. CPC B65G 43/08; B65G 3/04; B65G 2201/045

(57) ABSTRACT

Aspects of the present disclosure provide methods, devices, and systems for facilitating movement of material in at least one stockpile, for example to minimize variability and/or ensure a target level of one or more constituents of a product comprising material obtained from at least one stockpile. At least one computing device may receive pickup signal(s) indicating a plurality of pickup events associated with respective portions of the material. In response, the computing device may identify respective locations of the pickup events. At least one property of the material associated with the pickup events may be estimated. In response, the computing device may associate estimations of the at least one property with respective regions of the material associated with the pickup events. In response, the computing device may transmit respective locations of future pickup events. The computing device, in response, may receive future pickup signal(s) indicating the future pickup events.

### TECHNICAL FIELD

The present disclosure relates to material handling generally, and in particular to methods, devices, and systems for facilitating movement of material from at least one stockpile.

### BACKGROUND

A coal washing plant (CWP) or coal preparation plant (CPP) processes raw coal to remove waste materials and produce higher grade coal. However, existing CWPs and CPPs are not optimized.

### SUMMARY

Embodiments of the present disclosure may provide a more interactive production system in which the constituents of a plurality of different stockpiles of a raw mineral may be monitored to provide rapid feedback to the bulk material loaders for generating processed mineral with a desired quality. Embodiments of the present disclosure may provide methods, devices, and systems that minimize variability of one or more constituents of a product comprising material obtained from at least one stockpile. Embodiments of the present disclosure may provide methods, devices, and systems that minimize variability of relative ash content of a product comprising material obtained from at least one stockpile. Embodiments of the present disclosure may provide methods, devices, and systems that obtain a target calorific level of a product comprising material obtained from at least one stockpile. Embodiments of the present disclosure may provide methods, devices, and systems that ensure minimal deviation from a target level of ash content of a product comprising material obtained from at least one stockpile.

According to at least one embodiment, there is disclosed a method of facilitating movement of material from at least one stockpile comprising the material, the method comprising: causing at least one computing device to receive at least one pickup signal indicating at least a plurality of pickup events, each pickup event of the plurality of pickup events associated with a respective portion of the material; and causing the at least one computing device to, in response to at least the at least one pickup signal, identify at least respective locations of the pickup events.

In some embodiments, the method further comprises causing the at least one computing device to identify at least a respective pickup face of one or more stockpiles of the at least one stockpile of the material in response to, at least, at least some of the locations of the pickup events.

In some embodiments, the method further comprises causing the at least one computing device to segment the respective pickup face of each stockpile of the one or more stockpiles into a respective plurality of zones.

In some embodiments, the method further comprises causing the at least one computing device to segment each stockpile of the one or more stockpiles into a respective plurality of zones

In some embodiments, the method further comprises causing the at least one computing device to segment each stockpile of one or more stockpiles of the at least one stockpile into a respective plurality of zones.

In some embodiments, the method further comprises causing the at least one computing

device to receive at least one material-property signal indicating at least one property of the respective portions of the material associated with at least some of the pickup events.

In some embodiments, the method further comprises causing at least one sensor to measure at least one property of the respective portions of the material associated with at least some of the pickup events.

In some embodiments, the at least one property comprises measured quantities of at least one constituent of the respective portions of the material associated with the at least some of the pickup events.

In some embodiments, the at least one constituent comprises ash.

In some embodiments, the at least one constituent comprises calcium.

In some embodiments, the at least one constituent comprises sulfur.

In some embodiments, the method further comprises causing the at least one computing device to, in response to at least measurement of the at least one property of the respective portions of the material associated with the at least some of the pickup events, associate respective estimations of the at least one property with respective regions of a plurality of regions of the material.

In some embodiments, at least some of the regions of the plurality of regions are respective ones of the at least one stockpile.

In some embodiments, at least some of the regions of the plurality of regions are respective ones of the zones.

In some embodiments, the method further comprises causing the at least one computing device to, in response to at least associating the respective estimations of the at least one property with the respective regions, identify at least one respective location of at least one future pickup event.

In some embodiments, the at least one respective location of the at least one future pickup event comprises at least one respective region of the plurality of regions.

In some embodiments, causing the at least one computing device to identify the at least one respective location of the at least one future pickup event comprises causing the at least one computing device to identify the at least one respective location of the at least one future pickup event in response to at least one objective for a product comprising the respective portions of the material associated with the plurality of pickup events.

In some embodiments, the at least one objective for the product comprises minimizing a variability of a constituent of the product over time.

In some embodiments, the at least one objective for the product comprises minimizing a variability of relative ash content of the product over time.

In some embodiments, the at least one objective for the product comprises obtaining a target calorific level of the product.

In some embodiments, the at least one objective for the product comprises ensuring minimal deviation from a target level of ash content of the product.

In some embodiments, the method further comprises causing the at least one computing device to, in response to at least identifying the at least one respective location of the at least one future pickup event, transmit at least one future-pickup-location signal indicating at least the at least one respective location of the at least one future pickup event.

In some embodiments, causing the at least one computing device to transmit the at least one future-pickup-location signal comprises causing the at least one computing device to transmit the at least one future-pickup-location signal immediately after identifying the at least one respective location of the at least one future pickup event.

In some embodiments, the method further comprises causing at least one material handler to, in response to at least the at least one future-pickup-location signal, operate according to the at least one respective location of the at least one future pickup event.

In some embodiments, the method further comprises causing the at least one material handler to operate according to the at least one respective location of the at least one future pickup event comprises causing the at least one material handler to move to the at least one respective location of the at least one future pickup event.

In some embodiments, the method further comprises causing the at least one material handler to, in response to moving to the at least one respective location of the at least one future pickup event, pick up at least one future portion of the material at the at least one respective location of the at least one future pickup event.

In some embodiments, the method further comprises causing the at least one material handler to, in response to picking up the at least one future portion of the material, transmit at least one future pickup signal indicating at least the at least one future pickup event associated with the at least one future portion of the material.

In some embodiments, causing the at least one material handler to operate according to the at least one respective location of the at least one future pickup event comprises causing the at least one material handler to present the at least one respective location of the at least one future pickup event.

In some embodiments, the method further comprises causing the at least one computing device to associate measurements of the at least one property with the respective portions of the material associated with the at least some of the pickup events.

In some embodiments, the method further comprises causing the at least one computing device to, in response to at least respective deposits, in at least one deposit location, of the respective portions of the material associated with the at least some of the pickup events, obtain information indicative of at least the respective deposits.

In some embodiments, the method further comprises causing the at least one computing device to, in response to at least the information indicative of at least the respective deposits, estimate movement, of the respective portions of the material associated with the at least some of the pickup events, within at least one collection device positioned to receive, from the at least one deposit location, the respective portions of the material associated with the at least some of the pickup events.

In some embodiments, causing the at least one computing device to associate the measurements of the at least one property with the one or more respective portions of the material comprises causing the at least one computing device to associate the measurements of the at least one property with the one or more respective portions of the material according to at least the estimated movement, of the respective portions of the material associated with the at least some of the pickup events, within the at least one collection device.

In some embodiments, causing the at least one computing device to associate the measurements of the at least one property with the one or more respective portions of the material comprises causing the at least one computing device to associate the measurements of the at least one property with the one or more respective portions of the material according to at least measurements of respective volumes of the material associated with the at least some of the pickup events.

In some embodiments, causing the at least one computing device to associate the measurements of the at least one property with the one or more respective portions of the material comprises causing the at least one computing device to associate the measurements of the at least one property with the one or more respective portions of the material according to at least measurements of height of the material in the at least one collection device.

In some embodiments, the at least one collection device comprises a hopper.

In some embodiments, the at least one collection device comprises a breaker.

In some embodiments, the at least one collection device comprises a silo.

In some embodiments, the material comprises coal.

In some embodiments, the material comprises at least one mineral.

In some embodiments, the material comprises metal.

According to at least one embodiment, there is disclosed a system for facilitating movement of material from at least one stockpile comprising the material, the system comprising at least one computing device comprising at least one processor. The at least one computing device further comprises at least one memory storing processor-executable instructions that, when executed by the at least one processor, cause the at least one computing device to, at least: receive at least one pickup signal indicating at least a plurality of pickup events, each pickup event of the plurality of pickup events associated with a respective portion of the material; and in response to at least the at least one pickup signal, identify at least respective locations of the pickup events.

In some embodiments, the processor-executable instructions, when executed by the at least one processor, further cause the at least one computing device to, at least, identify at least a respective pickup face of one or more stockpiles of the at least one stockpile of the material in response to, at least, at least some of the locations of the pickup events.

In some embodiments, the processor-executable instructions, when executed by the at least one processor, further cause the at least one computing device to, at least, segment the respective pickup face of each stockpile of the one or more stockpiles into a respective plurality of zones.

In some embodiments, the processor-executable instructions, when executed by the at least one processor, further cause the at least one computing device to, at least, segment each stockpile of the one or more stockpiles into a respective plurality of zones.

In some embodiments, the processor-executable instructions, when executed by the at least one processor, further cause the at least one computing device to, at least, segment each stockpile of one or more stockpiles of the at least one stockpile into a respective plurality of zones.

In some embodiments, the processor-executable instructions, when executed by the at least one processor, further cause the at least one computing device to, at least, receive at least one material-property signal indicating at least one property of the respective portions of the material associated with at least some of the pickup events.

In some embodiments, the system further comprises at least one analyzer operable to measure at least one property of the respective portions of the material associated with at least some of the pickup events.

In some embodiments, the system further comprises at least one analyzer comprising: at least one analyzer processor; and at least one analyzer sensor. The at least one analyzer further comprises at least one analyzer memory storing analyzer processor-executable instructions that, when executed by the at least one analyzer processor, cause the at least one analyzer to, at least: cause the at least one analyzer sensor to measure at least one property of the respective portions of the material associated with at least some of the pickup events.

In some embodiments, the at least one property comprises measured quantities of at least one constituent of the respective portions of the material associated with the at least some of the pickup events.

In some embodiments, the at least one constituent comprises ash.

In some embodiments, the at least one constituent comprises calcium.

In some embodiments, the at least one constituent comprises sulfur.

In some embodiments, the processor-executable instructions, when executed by the at least one processor, further cause the at least one computing device to, at least, in response to at least measurement of the at least one property of the respective portions of the material associated with the at least some of the pickup events, associate respective estimations of the at least one property with respective regions of a plurality of regions of the material.

In some embodiments, at least some of the regions of the plurality of regions are respective ones of the at least one stockpile.

In some embodiments, at least some of the regions of the plurality of regions are respective ones of the zones.

In some embodiments, the processor-executable instructions, when executed by the at least one processor, further cause the at least one computing device to, at least, in response to at least associating the respective estimations of the at least one property with the respective regions, identify at least one respective location of at least one future pickup event.

In some embodiments, the at least one respective location of the at least one future pickup event comprises at least one respective region of the plurality of regions.

In some embodiments, causing the at least one computing device to identify the at least one respective location of the at least one future pickup event comprises causing the at least one computing device to identify the at least one respective location of the at least one future pickup event in response to at least one objective for a product comprising the respective portions of the material associated with the plurality of pickup events.

In some embodiments, the at least one objective for the product comprises minimizing a variability of a constituent of the product over time.

In some embodiments, the at least one objective for the product comprises minimizing a variability of relative ash content of the product over time.

In some embodiments, the at least one objective for the product comprises obtaining a target calorific level of the product.

In some embodiments, the at least one objective for the product comprises ensuring minimal deviation from a target level of ash content of the product.

In some embodiments, the processor-executable instructions, when executed by the at least one processor, further cause the at least one computing device to, at least, in response to at least identifying the at least one respective location of the at least one future pickup event, transmit at least one future-pickup-location signal indicating at least the at least one respective location of the at least one future pickup event.

In some embodiments, causing the at least one computing device to transmit the at least one future-pickup-location signal comprises causing the at least one computing device to transmit the at least one future-pickup-location signal immediately after identifying the at least one respective location of the at least one future pickup event.

In some embodiments, the system further comprises at least one material handler comprising at least one handler processor. The at least one material handler further comprises at least one handler memory storing handler processor-executable instructions that, when executed by the at least one handler processor, cause the at least one material handler to, at least: in response to at least the at least one future-pickup-location signal, operate according to the at least one respective location of the at least one future pickup event.

In some embodiments, causing the at least one material handler to operate according to the at least one respective location of the at least one future pickup event comprises causing the at least one material handler to move to the at least one respective location of the at least one future pickup event.

In some embodiments, the handler processor-executable instructions further comprise handler processor-executable instructions that, when executed by the at least one processor, further cause the at least one material handler to, at least, in response to moving to the at least one respective location of the at least one future pickup event, pick up at least one future portion of the material at the at least one respective location of the at least one future pickup event.

In some embodiments, the handler processor-executable instructions further comprise handler processor-executable instructions that, when executed by the at least one processor, further cause the at least one material handler to, at least, in response to picking up the at least one future portion of the material, transmit at least one future pickup signal indicating at least the at least one future pickup event associated with the at least one future portion of the material.

In some embodiments, causing the at least one material handler to operate according to the at least one respective location of the at least one future pickup event comprises causing the at least one material handler to present the at least one respective location of the at least one future pickup event.

In some embodiments, the processor-executable instructions, when executed by the at least one processor, further cause the at least one computing device to, at least, associate measurements of the at least one property with the respective portions of the material associated with the at least some of the pickup events.

In some embodiments, the processor-executable instructions, when executed by the at least one processor, further cause the at least one computing device to, at least, in response to at least respective deposits, in at least one deposit location, of the respective portions of the material associated with the at least some of the pickup events, obtain information indicative of at least the respective deposits.

In some embodiments, the system further comprises at least one collection device positioned to receive, from the at least one deposit location, the respective portions of the material associated with the at least some of the pickup events. In such embodiments, the processor-executable instructions, when executed by the at least one processor, cause the at least one computing device to, in response to at least the information indicative of at least the respective deposits, estimate movement, of the respective portions of the material associated with the at least some of the pickup events, within the at least one collection device.

In some embodiments, causing the at least one computing device to associate the measurements of the at least one property with the one or more respective portions of the material comprises causing the at least one computing device to associate the measurements of the at least one property with the one or more respective portions of the material according to at least the estimated movement, of the respective portions of the material associated with the at least some of the pickup events, within the at least one collection device.

In some embodiments, the system further comprises at least one volume sensor operable to sense respective volumes of the material associated with the at least some of the pickup events. In such embodiments, causing the at least one computing device to associate the measurements of the at least one property with the one or more respective portions of the material comprises causing the at least one computing device to associate the measurements of the at least one property with the one or more respective portions of the material according to at least measurements, by the at least one volume sensor, of the respective volumes of the material associated with the at least some of the pickup events.

In some embodiments, the system further comprises at least one height sensor operable to sense height of the material in the at least one collection device. In such embodiments, causing the at least one computing device to associate the measurements of the at least one property with the one or more respective portions of the material comprises causing the at least one computing device to associate the measurements of the at least one property with the one or more respective portions of the material according to at least measurements, by the at least one height sensor, of height of the material in the at least one collection device.

In some embodiments, the at least one collection device comprises at least one hopper.

In some embodiments, the at least one collection device comprises at least one breaker.

In some embodiments, the at least one collection device comprises at least one silo.

In some embodiments, the material comprises coal.

In some embodiments, the material comprises at least one mineral.

In some embodiments, the material comprises metal.

### BRIEF DESCRIPTION OF THE DRAWINGS

Reference will now be made, by way of example only, to the accompanying drawings which show example embodiments of the present application, and in which:

FIG. 1 is a schematic diagram of a system for facilitating movement of material in at least one stockpile at a coal washing plant (CWP) in accordance with embodiments of the present disclosure;

FIG. 2 is a schematic diagram of a stockpile at the CWP of FIG. 1;

FIG. 3 illustrates an example process of identifying a pickup face of a stockpile, in accordance with embodiments of the present disclosure;

FIG. 4 illustrates an example of a pickup face of the stockpile of FIG. 3, in accordance with embodiments of the present disclosure;

FIG. 5 illustrates an example method of segmenting a pickup face of the stockpile of FIG. 3 into a respective plurality of zones, in accordance with embodiments of the present disclosure;

FIG. 6 illustrates another example method of segmenting a pickup face of the stockpile of FIG. 3 into a respective plurality of zones, in accordance with embodiments of the present disclosure;

FIG. 7A is an schematic diagram of an example collection device, an example analyzer, and an example conveyor in the system of FIG. 1, in accordance with embodiments of the present disclosure;

FIG. 7B illustrates an example of weighting measurements of ash in the measured coal, in accordance with embodiments of the present disclosure;

FIG. 8 is a schematic diagram of an example procedure for reducing ash content variance in the system of FIG. 1, in accordance with embodiments of the present disclosure;

FIG. 9 illustrates an example procedure for facilitating movement of material in at least one stockpile, in accordance with embodiments of the present disclosure;

FIG. 10 illustrates an example of a computing device, a collection device, an analyzer, and a bulk material handler communicating with each other in the system of FIG. 1, in accordance with embodiments of the present disclosure;

FIG. 11 is an example of a chart of frequency vs ash content variance, and a chart of average yield vs ash content variance for the CWP of FIG. 1 according to one embodiment;

FIG. 12 is an example of a chart of yield improvement and impact vs a reduction in ash variance according to one embodiment;

FIG. 13A illustrates ash content vs time for three different zones in a stockpile according to one embodiment;

FIG. 13B illustrates ash content vs time for three different zones in a stockpile according to one embodiment;

FIG. 14 is a chart of the differences of ash content for a plurality of stockpiles according to one embodiment; and

FIG. 15 illustrates ash content vs time measured at a coal analyzer according to one embodiment.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art.

As noted above, a coal washing plant (CWP) or coal preparation plant (CPP) processes raw coal to remove waste materials and produce higher grade coal. The processing of the raw materials attempts to reach expected constituent levels, e.g., ash, calcium, and sulfur, in the processed or “clean coal”. The more waste material removed from coal, the lower the total ash content, the greater the market value and the lower the transportation costs.

The raw coal delivered from the mine to the coal wash plant may be called run-of-mine, or ROM coal, which may comprise coal, rocks, middlings, minerals and contaminants. Contaminants are usually introduced by the mining process and may include machine parts, used consumables and parts of ground engaging tools. The raw coal can have a large variability of moisture, ash content and maximum particle size.

The raw coal is typically stored in a stockpile near the CWP, and conveyed to the CWP when required. The stockpile provides surge capacity to the CWP, so that the raw coal may be delivered at various times and amounts, while enabling the CWP to be fed coal at a lower, constant rate. A simple stockpile is formed by machinery dumping coal into a pile, either from dump trucks, pushed into heaps with bulldozers or from conveyor booms. Front-end loaders and bulldozers may be used to move the raw coal from the stockpile into feeders. Raw coal handling is part of the larger field of bulk material handling, and is a complex and vital part of the CWP.

Sampling of the coal is another part of the process in the production of coal. The measurement of constituents, such as ash, moisture, calorific value, sulfur (S), iron (Fe), Calcium (Ca), Sodium (Na), and other element constituents of the coal may be reported by various analyzers. A routine sample may be taken at a set frequency, either over a period of time or per shipment. Coal sampling may comprise several different types of sampling devices at several different points in the CWP. Coal sampling may occur in several parts of the coal production, e.g. on pit, at stockpiles and at the plant. Typically, samples are collected only three times a week per stockpile. Samples of the raw coal also may be taken before entering the plant. Samples of the refuse may be taken to see what the CWP missed. Then the processed coal may be sampled to see exactly what is being shipped. Typically, the samples are sent to an independent lab for testing where the results may be shared with coal quality geologists for quality control. The sampling information may be calibrated periodically to confirm output goals and aid in future blending processes.

A direct correlation is identified between variability of constituents of coal and yield of a product with a desired quality (e.g., clean coal with a target ash level). For example, ash variability at a coal collection device (e.g., coal feed) may reduce ability to optimize the coal production at a CWP and decrease yield of clean coal and increase waste of material. Therefore, the higher the variability, the lower the perceived yield.

The present disclosure illustrates a system for increasing yield in production process, which includes a plurality of stockpiles of material, e.g., coal, each stockpile including a plurality of zones, each zone having a different constituent content, e.g., ash content. At least one computing device directs at least one bulk material handler to collect, transport and dump loads of material from the plurality of zones of the plurality of stockpiles to a collection device based on the constituent content value of each zone of each stockpile for increasing yield of a final product. Each load of material is tracked and analyzed, whereby the constituent content value of each load of material may be used to update the corresponding constituent content value of the zone of origin for subsequent analysis and direction of the bulk material handlers.

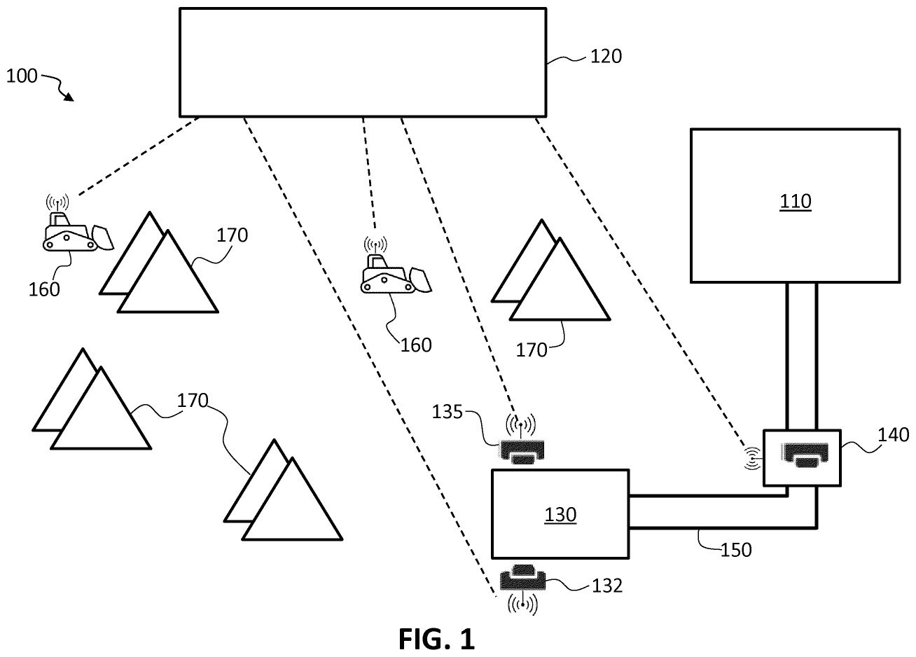

The methods, devices, and systems for facilitating movement of material in at least one stockpile in accordance with embodiments of the present disclosure may be utilized at a mineral preparation plant, e.g., a coal washing plant (CWP) 110 illustrated in FIG. 1 or any other production plant that would benefit therefrom. In other words, while FIG. 1 and other part of the present disclosure is illustrated based on a system at a CWP (e.g., CWP 110), a person skilled in the art would readily understand that methods, devices, and/or systems illustrated in the present disclosure may be utilized at other production plants, for example plants for zinc or copper. FIG. 1 illustrates a system 100 for facilitating movement of material in at least one stockpile at a coal washing plant (CWP) 110 in accordance with embodiments of the present disclosure. The system 100 may include at least one computing device 120. The CWP 110 may or may not be part of the system 100. In some embodiments, the system 100 may also include at least one of at least one collection device 130, at least one analyzer 140, at least one conveyor 150, or at least one bulk material handler 160. It should be noted that FIG. 1 illustrates that the system 100 includes one CWP 110, one computing device 120, one collection device 130, one analyzer 140, and one conveyor 150 for illustration purpose only. In other words, in some embodiments, the system 100 may include multiple one CWPs 110, multiple computing devices 120, multiple collection devices 130, multiple analyzers 140, and/or multiple conveyors 150. It should also be noted that FIG. 1 illustrates that the system include a couple of bulk material handers 160, the system 100 may include any number of bulk material handers 160 (e.g., one bulk material handler 160 or multiple bulk material handlers 160).

The CWP 110 may receive, for example through the conveyor 150, raw material acquired from at least one stockpile 170 and process the raw material to remove waste materials and produce higher grade coal. The processing of the raw materials attempts to reach expected constituent levels, e.g., ash, calcium, and sulfur, in the processed or clean coal.

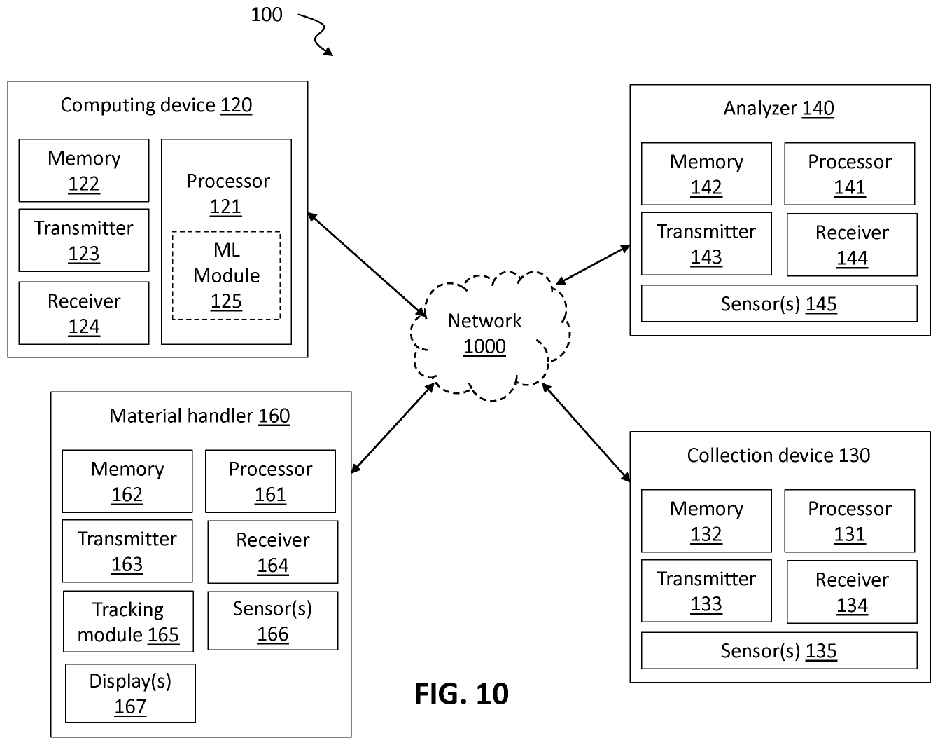

Each of the at least one computing device 120 may include at least one processor and/or at least one memory as illustrated below and elsewhere in the present disclosure (e.g., FIG. 10). The computing device 120 may be configured to execute processor-executable instructions stored on the at least one memory, such as local or cloud based memory stores, included in the computing device 120 (e.g., memory 122 as illustrated in FIG. 10). The at least one computing device 120 may receive at least one pickup signal indicating at least a plurality of pickup events, for example from at least one bulk material handler 160. Here, each pickup event of the plurality of pickup events may be associated with a respective portion of the material that was picked up during the pickup event and subsequently transported and deposited at another location. The at least one computing device 120 may, in response to at least the at least one pickup signal, may identify at least respective locations of the pickup events.

In some embodiments, the at least one computing device 120 may identify at least a respective pickup face of at least one stockpile 170 of the material. In some embodiments, the at least one computing device 120 may segment respective pickup face of each of or one or more of the at least stockpile 170 or segment one or more stockpiles of the at least one stockpile 170 into a respective plurality of zones. In some embodiments, the at least one computing device 120 may associate estimations of at least one property of the material with respective regions (e.g., stockpile or zone) of the material. In some embodiments, the at least one computing device 120 may identify at least one respective location of at least one future pickup event. In some embodiments, the at least one computing device may transmit, to at least one bulk material handler 160, at least one future-pickup-location signal indicating the at least one respective location of the at least one future pickup event. The operation of at least one computing device 120, which may be caused by processor-executable instructions stored on the at least one memory of the at least one computing device 120, is further illustrated below and elsewhere in the present disclosure.

In some embodiments, the system 100 may include at least one, or a plurality of, bulk material handlers 160, for example, but without limiting to, bulldozers, front end loaders, some other vehicles that may be able to carry some material, and/or some other aircrafts (e.g., drones) that may be able to carry some material. In some embodiments, the at least one bulk material handler 160, while interacting with at least one component (e.g., at least one computing device 120) of the system, may be not part of the system 100. The material handlers 160 may include at least one communication and tracking unit, module, and/or apparatus, e.g., global positioning system (GPS) module. For example, as shown in FIG. 10, the material handlers 160 may include at least one of a transmitter 163, a receiver 164, or a tracking module 165. Due to the communication and tracking unit, module, and/or apparatus, location of at least some of the material handlers 160 may be tracked and communicated to the at least one computing device 120.

The communication(s) between the material handlers 160 and the at least one computing device 120 may include receiving, by the at least one computing device 120, at least one signal from the bulk material handlers 160 and/or sending, by the at least one computing device 120, at least one signal to the bulk material handlers 160.

The at least one signal transmitted from the material handlers 160 to the at least one computing device 120 may include at least one pickup signal indicating at least a plurality of pickup events, where each pickup event of the plurality of pickup events may be associated with a respective portion of the material that was picked up during the pickup event and subsequently transported and deposited at another location. In some embodiments, the material handler 160 may transmit, to the at least one computing device 120, a signal that includes a location where the material handler 160 picked up the material and/or time when the material handler picked up the material. In some embodiments, the material handler 160 may transmit, to the at least one computing device 120, a signal indicating that the pickup event has occurred. In this case, the at least one computing device 120 may acquire location and/or time of the pickup event based on for example the signal received from the material handler 160.

The at least one signal transmitted from the at least one computing device 120 to at least one of the material handlers 160 may include at least one future-pickup-location signal, which indicates at least the at least one respective location of the at least one future pickup event (e.g., future pickup event associated with at least some portion of the material remaining at one of the stockpiles 170). In other words, the at least one computing device 120 may transmit, to the material handler 160, a signal that indicates a future location where the material handler 160 should pick up the material.

In some embodiments, the bulk material handlers 160 may be autonomous vehicles, whereby the at least one computing device 120 sends signals thereto via a suitable communication network to control the movement and loading/unloading (i.e., pickup/deposit) portions of the material. In some embodiments, the bulk material handlers 160 may be entirely autonomous vehicles. The bulk material handlers 160 may be partially autonomous vehicles (e.g., some functions require human operators). In some embodiments, the bulk material handlers 160 may be human operated, whereby the at least one computing device 120 sends signals via a suitable communication network to direct the movement of the human operator for loading (i.e., pickup) and unloading (e.g., deposit) of portions of the material. The time taken for each bulk material handler 160 to collect, transport and dump (e.g., deposit at the collection device 130) the portions of the material, which is typically between 1-5 minutes, may also be measured and communicated to the at least one computing device 120 by one or more sensors 166 (e.g., position sensors and weight sensors) on the bulk material handlers 160, for factoring into the processing and/or further optimization. In some embodiments, a Wenco™ system (not shown in FIG. 1) may be used to provide the at least one computing device 120 with location and timing information and data related to the bulk material handlers 160.

Since the constituents of the material (e.g., coal), such as ash, moisture, calorific value, sulfur (S), iron (Fe), Calcium (Ca), Sodium (Na) and Phosphorous (P), vary from different sources, e.g., mine to mine and from vein to vein in the same mine, a plurality of stockpiles 170, e.g., each from a different source and with different constituent levels, may be disposed around a yard proximate the CWP 110, typically within a kilometer or within 500 m. Accordingly, the at least one computing device 120 may better control the constituent levels in the final product by selecting which combination of loads from each stockpile 170 best produces the desired constituent levels in a product (e.g., finished product). The inventory levels of each stockpile 170, also may be taken into consideration when the geologists select the stockpiles 170 to design the desired blend of mineral.

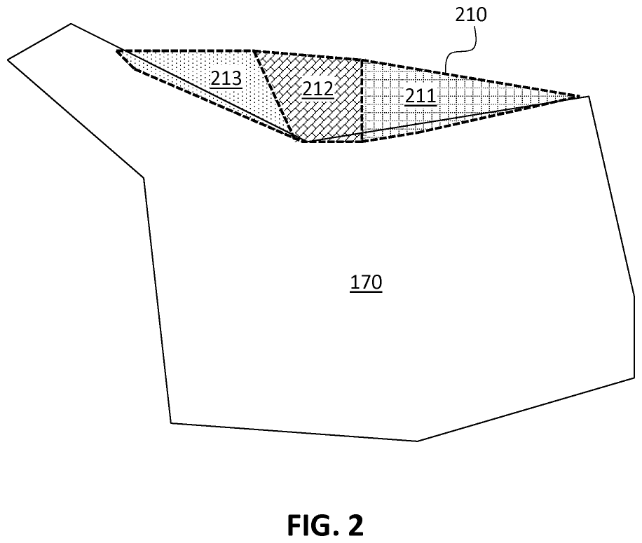

With reference to FIG. 2, to further increase the accuracy and control of the constituent

levels of the finished product, each stockpile 170 may include a working area 210, which is accessible by the bulk material handlers 160, from which the bulk material handlers 160 pick up a load of material.

In some embodiments, the at least one computing device 120 may identify locations and/or boundaries of the stockpile 170 (e.g., shape of the stockpile 170 when viewed from top).

The at least one computing device 120 may identify locations and boundaries of the stockpile 170 based on one or more pieces of data, for example but not limited to satellite image of the stockpile 170, records of pickup events acquired from for example an internal database of the system 100, data (e.g. time and location of previous material pickup and/or deposit events and/or time and location of the at least one bulk material handler 160) acquired from an external system such as Wenco™ system. The internal database of the system 100 may be included in the at least one computing device 120. In some embodiments, the internal database of the system 100 may be included in a separate device.

In some embodiments, the at least one computing device 120 may identify the working area 210. In some embodiments, the working area 210 may be further divided, for example by the at least one computing device 120, into a plurality of zones. In some embodiments, the respective portion of the material loaded from each zone may have different constituent levels. In some embodiments, each working area may be divided into multiple polygonal zones, e.g., Left zone 211, Middle zone 212 and Right zone 213, for example as shown in FIG. 2. It should be however noted that in some embodiments, the working area 210 may not be divided into a plurality of zones, for example when the working area 210 is too small to divide or when the stockpile 170 is too small to divide. In some embodiments, after further operation and/or according to the feedback of the operators, the at least one computing device 120 may re-identify the working area 210 and/or re-divide the working area 210 into a plurality of (polygonal) zones. In some embodiments, after further operation and/or according to the feedback of the one or more devices in the system 100 and/or the operators, the at least one computing device 120 may update the analytics and have a different number of zones on some or all of the stockpiles 170. In some embodiments, the at least one computing device 120 may determine and/or update the number and/or size of each zone (e.g., zones 211, 212, 213) by combining the existing zones based on the GPS traces from the bulk material handlers 160 to re-identify the working area 210, e.g., the face of each stockpile 170. Then, the at least one computing device 120 may re-divide the re-identified working area 210 into a plurality of zones. The working areas 210 and zones 211, 212 and 213 may be constantly updated for example by the at least one computing device 120, providing a more reliable source to base the remaining part of the analytics.

In some embodiments, at least one computing device 120 may identify at least a respective pickup face of one or more stockpiles of the at least one stockpile of the material. The at least one computing device 120 may identify the respective pickup face in response to, at least, at least some of the locations of the pickup events. In some embodiments, the at least one computing device 120 may acquire the at least some of the locations of the pickup events from the at least one pickup signal received from, for example, one or more material handlers 160. In some embodiments, the at least one computing device 120 may acquire the at least some of the locations of the pickup events from some other signal received from an external system (e.g., Wenco™ system). In some embodiments, the at least one computing device 120 may acquire the at least some of the locations of the pickup events based on one or more pieces of data or information provided, in some other way, to the at least one computing device 120.

In some embodiments, the at least one computing device 120 may identify at least the respective pickup face based on one or more pieces of data, for example but not limited to satellite image of the stockpile 170, records of pickup events acquired from for example an internal database of the system 100, records of tracked time and location of locations and/or movements of one or more material handlers 160 acquired from the internal database of the system 100, data (e.g. time and location of previous material pickup and/or deposit events and/or time and location of the at least one bulk material handler 160) acquired from an external system such as Wenco™ system. The internal database of the system 100 may be included in the at least one computing device 120. In some embodiments, the internal database of the system 100 may be included in a separate device.

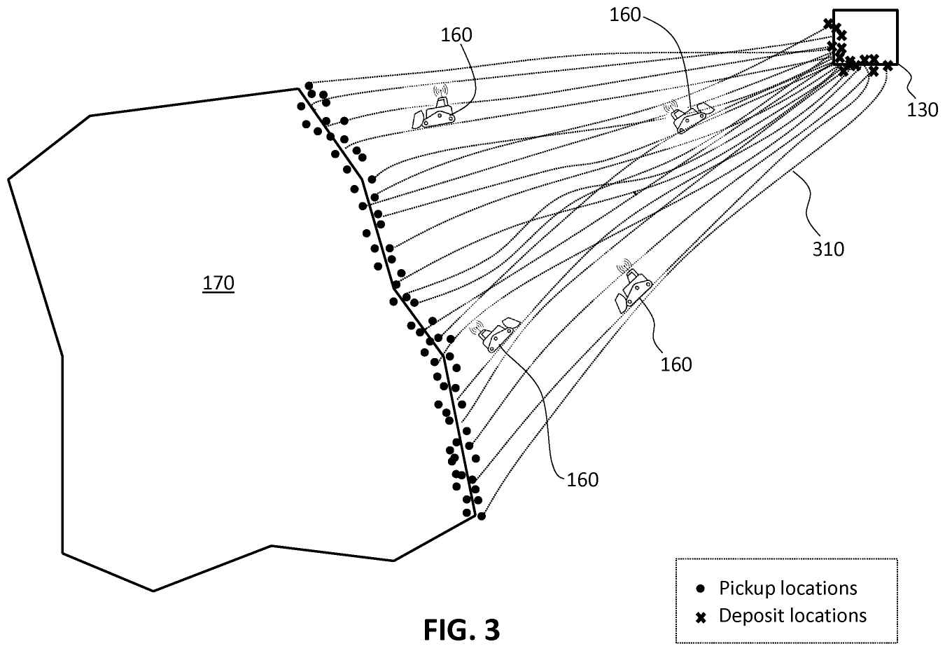

FIG. 3 illustrates an example process of identifying a pickup face of a stockpile 170, in accordance with embodiments of the present disclosure. As stated above, in some embodiments, locations of one or more bulk material handlers 160 may be tracked and communicated to the at least one computing device 120, for example using at least one communication and tracking unit, module, and/or apparatus (e.g., transmitter 163, receiver 164, and/or tracking module 165 in FIG. 10). An example of tracking of the locations and/or movements of one or more material handlers 160 is provided in FIG. 3 as the tracking information 310. It should be noted that while the reference numeral 310 is connected to only one dashed line (or dotted line) in FIG. 3, all of similar dashed lines (or dotted lines) shown in FIG. 3 represent the tracking information 310 or the locations and/or movements of one or more material handlers 160. In some embodiments, the tracking information 310 may be stored in an internal database of the system 100. The internal database of the system 100 may be included in the at least one computing device 120. In some embodiments, the system 100 may comprise a separate device for the database for the tracking information.

In some embodiments, at least some operation of the one or more material handlers 160 may be tracked. For example, each or at least some of the pickup events at the stockpile 170 may be identified and tracked (or recorded). Accordingly, locations where pickup events occurred may be identified, for example by the one or more material handlers 160. Each of the identified and tracked pickup locations associated with pickup events at the stockpile 170 is illustrated in FIG. 3 as a dot (●). In a similar manner, each or at least some of the deposit events at the stockpile 170 may be identified and tracked (or recorded). Each of the identified and tracked deposit locations associated with deposit events at the collection device 130 is illustrated in FIG. 3 as an X (×). For each of identified pickup event, each material handler 160 may transmit, to the at least one computing device 120, at least one pickup signal indicating the pickup event. In some embodiments, the at least one pickup signal may indicate at least one of the location of the pickup event or the time of the pickup event. In other words, the at least one pickup signal may include at least one of the location of the pickup event or the time of the pickup event. However, in some embodiments, the at least one pickup signal may not directly indicate the location and/or time of the pickup events. Instead, the at least one computing device 120 may acquire location and/or time of the pickup events from some other signal received from an external system (e.g., Wenco™ system). In some embodiments, the at least one computing device 120 may acquire the location and/or time of the pickup events based on one or more pieces of data or information provided, in some other way, to the at least one computing device 120.

Similarly, for each of identified deposit event, each material handler 160 may transmit, to the at least one computing device 120, at least one deposit signal indicating the deposit event. In some embodiments, the at least one deposit signal may indicate at least one of the location of the deposit event or the time of the deposit event. In other words, the at least one deposit signal may include at least one of the location of the deposit event or the time of the deposit event. However, in some embodiments, the at least one deposit signal may not directly indicate the location and/or time of the deposit events. Instead, the at least one computing device 120 may acquire location and/or time of the deposit events from some other signal received from an external system (e.g., Wenco™ system). In some embodiments, the at least one computing device 120 may acquire the location and/or time of the deposit events based on one or more pieces of data or information provided, in some other way, to the at least one computing device 120.

Further illustration regarding identifying pickup and deposit events is provided. In some embodiments, high precision GPS module (or sensor) may be installed on top of or otherwise on the bulk material handlers 160, whereby the GPS traces are frequently updated, e.g. under every 20 seconds, under every 10 seconds, or under every 5 seconds. Pickup and deposit indicators (load and dump indicators) may also be provided on the bulk material handlers 160 to transmit the at least one pickup signal to the at least one computing device 120 regarding timing of actual pickup and deposit events (e.g., loading and dumping of loads). Accordingly, the at least one computing device 120 may identify when and where each load is collected by the bulk material handlers 160 from each stockpile 170. In other words, in response to at least the at least one pickup signal, the at least one computing device 120 may identify at least respective locations and/or time of the pickup events.

In some embodiments, the pickup events and/or deposit events may be identified by the one or more material handlers 160 autonomously for example based on movement of at least one element (e.g. blade) of the material handlers. In some embodiments, the pickup events and/or deposit events may be identified when a human operators of the material hander 160, for example, presses a button for pickup or deposit operation.

Using information related to location and time of pickup events, the at least one computing device 120 may be able to associate respective estimations of at least one property of the material (e.g., at least one constituent of the analyzed material) with respective regions of the material, as further illustrated below and elsewhere in the present disclosure. It should be noted that each region may be a stockpile 170 in which the pickup event occurred, and/or one of the zones 211, 212, and 213 in which the pickup event occurred. In one example, the at least one computing device 120 may correlate the estimated ash values of the material back to the corresponding pickup event, stockpile 170 and/or zone 211, 212 or 213. The correct location and time of each pickup event (pickup event of the material) may be useful to estimate the “expected ash level” for the future pickups (next loads) from the stockpile 170 and/or zone 211, 212 or 213.

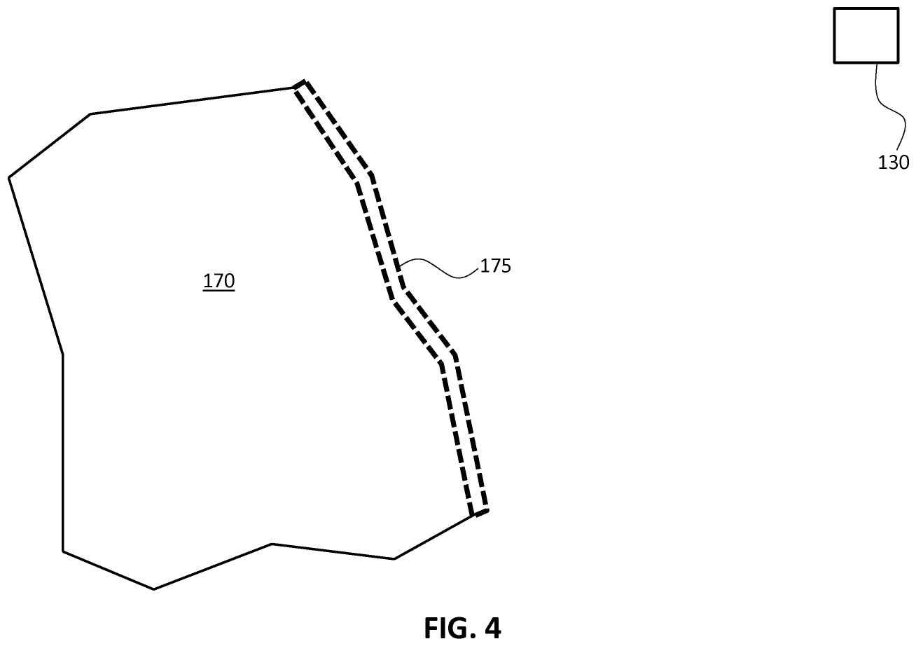

When enough information related to locations of the pickup events are collected as shown in FIG. 3, the at least one computing device 120 may identify at least a respective pickup face of the stockpile 170 based on at least some of the locations of the pickup events. For example, in some embodiments, pickup faces may be identified by a curve-fitting or piecewise-linear-fitting function of recent pickup events. In some embodiments, the at least one computing device 120 may identify the pickup face of the stockpile 170 using information received from another device or system, for example a satellite image of the stockpile 170 and/or information related to previously identified pickup face of the stockpile 170. An example pickup face 175 of the stockpile 170 identified through the process of FIG. 3 is shown in FIG. 4. The example pickup face 175 of the stockpile 170 is identified using dashed lines in FIG. 4.

In some embodiments, at least one computing device 120 may segment the respective pickup face 175 of each stockpile 170 into a respective plurality of zones.

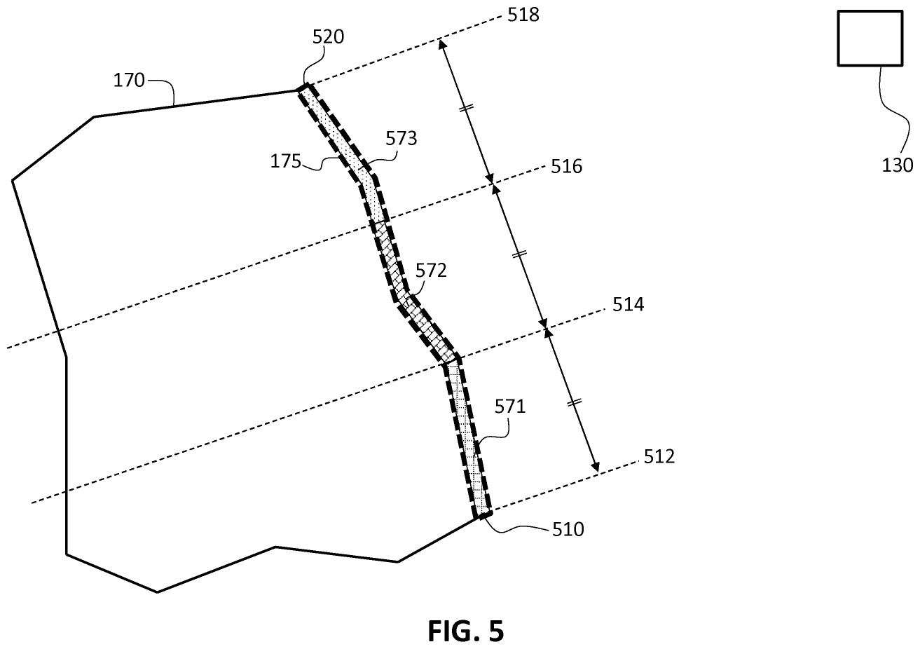

FIG. 5 illustrates an example method of segmenting a pickup face 175 of the stockpile 170 into a respective plurality of zones, in accordance with embodiments of the present disclosure. As shown in FIG. 5, in some embodiments, the pickup face 175 of the stockpile 170 identified in FIG. 4 may be evenly segmented into three zones 571, 572, and 573. Specifically, once the pickup face 175 is acquired, one end 510 of the pickup face 175 and the other end of the pickup face 175 may be identified. The distance between the two ends 510 and 520 may be determined based on the distance between virtual lines 512 and 518. The distance between the virtual lines 512 and 518 may be evenly divided into three, as identified by virtual division lines 514 and 516. Then, the at least one computing device 120 may segment the pickup face 175 of the stockpile 170 into the three zones 571, 572, and 573 using the virtual division lines 514 and 516, as shown in FIG. 5.

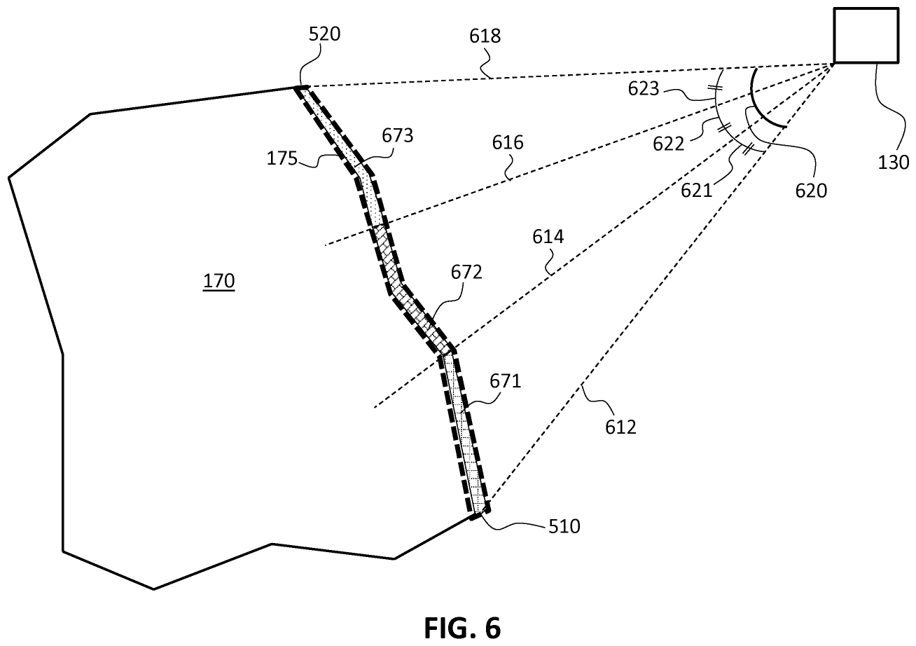

FIG. 6 illustrates an example method of segmenting a pickup face 175 of the stockpile 170 into a respective plurality of zones, in accordance with embodiments of the present disclosure. As shown in FIG. 6, in some embodiments, the pickup face 175 of the stockpile 170 identified in FIG. 4 may be segmented into three zones 671, 672, and 673 based on an angular distance between the two ends 510 and 520 from a certain location, for example an angle 620 between two virtual sight lines 612 and 618 from a location of the collection device 130. The angle 620 may be evenly divided into three equal angles 621, 622, and 623, as identified by virtual division lines 614 and 616. Then, the at least one computing device 120 may segment the pickup face 175 of the stockpile 170 into the three zones 671, 672, and 673 using the virtual division lines 614 and 616, as shown in FIG. 6.

In some embodiments, at least one computing device 120 may segment each or one or more stockpile(s) 170 into a respective plurality of zones. Put another way, for example, the at least one computing device 120 may segment the stockpile 170 into a plurality of zones, with or without first identifying the pickup face 175 (e.g., identifying the pickup face 175 may not be required). A person skilled in the art would readily understand that the method illustrated above and in FIGS. 5 and 6 may be performed without having to identify a pickup face (e.g., pickup face 175) of a stockpile. Referring to FIG. 5, the two ends 510 and 520 of the stockpile 170 may be identified without requiring to first identify the pickup face 175. As such, the virtual lines 512 and 518 may be obtained without using the pickup face 175, and the distance between the virtual lines 512 and 518 may be evenly divided into three in the same manner as illustrated above, without using the pickup face 175. In a similar manner, referring to FIG. 6, the two ends 510 and 520 of the stockpile 170 may be identified without requiring to first identify the pickup face 175. As such, the two virtual sight lines 612 and 618 and therefore the angle 620 may be obtained without using the pickup face 175. Accordingly, the angle 620 may be evenly divided into the three angles 621, 622, and 623 in the same manner as illustrated above, without using the pickup face 175.

Referring back to FIG. 1, the system 100 may include at least one collection device 130. However, it should be noted that in some embodiments, the collection device 130 may not be part of the system 100. In some embodiments, the collection device 130, for example but not limited to a hopper or a breaker bin or a silo or some other apparatus to receive and/or contain/carry at least temporarily some material, may be provided in the yard to enable the bulk material handlers 160 to deposit portions of the material picked up from one or more stockpiles 170. In other words, the collection device 130 may be positioned to receive, in at least one deposit location, the portions of the material picked up from the one or more stockpiles 170. After the portions of the material are deposited into the collection device 130, the deposited portions of the material may be transported to the CWP 110 via a conveyor 150. In some embodiments, there may be other possible configurations for the collection devices 130, such as: 1) at least one hopper, 2) at least one breaker, 3) at least one silo, 4) at least one hopper and at least one breaker, 5) at least one breaker and at least one silo, 6) at least one hopper and at least one silo, and 7) at least one hopper, at least one breaker and at least one silo. In some embodiments, the at least one computing device 120 may dynamically detect when a portion of the material is picked up by each bulk material handler 160 from one of the plurality of stockpiles 170, may identify the corresponding zone, e.g., zone 571, 572, 573, 671, 672, and/or 673 from the corresponding stockpile 170, and define when the portion of the material is deposited at the collection device 130. Put another way, in at least one deposit location (e.g., at the collection device 130), the at least one computing device 120 may, in response to at least respective deposits of portions of the material associated with respective pickup events, obtain information indicative of at least the respective deposits of the respective portions of the material.

In some embodiments, one or more sensors 135 may be part of the collection device 130 or provided proximate to the collection device 130. The one or more sensors 135 may be provided to detect at least the time and amount of deposited portions of the material (e.g., time and amount of each portion of the material, or load, deposited into the collection device 130). The one or more sensors 135 may comprise one or more level, height, or volume sensors in the collection device 130. In some embodiments, at least one of deposit time, volume of portion of the material (load volume), flow rate of the deposited material through (or within) the collection device 130, or the distance and speed of the conveyor 150 to the analyzer 140 may be used to estimate movement of the deposited material (e.g., assess the moment the portions of deposited material reaches at the analyzer 140). The estimation of the movement of the deposited material may be needed to determine the one or more constituent values (e.g., measured quantities of one or more constituents) for portions of the material associated with respective pickup events (each portion of the material or load may be associated with a pickup event) and estimate the one or more constituent values of each zone (e.g., zone 571, 572, 573, 671, 672, and/or 673) or each stockpile 170 associated with the corresponding portion of the material (e.g., corresponding load) or other region of the material. The one or more sensors 135 may detect the height of the material in the collection device 130, so that the at least one computing device 120 may estimate volume, retention time, and/or mixing factors. In some embodiments, the one or more sensors 135, e.g. acoustic sensors, may be mounted on top of the collection device 130 and pointing to the bottom of the collection device 130, whereby different technologies may be used to detect the height of the material in the collection device 130.

In some embodiments, an analyzer 140 may be provided between the collection device 130 and the CWP 110 and configured to measure at least one of the constituent values (e.g., measured quantities of ash, calcium, and/or sulfur) of portions of the material or calorific level of portions of the material on the conveyor 150 or otherwise detected by the at least one analyzer 140. In response to the measurement, the one or more constituent values of the measured portions of the material (e.g., measured quantities of at least one constituent of the measured portions of the material) may be transmitted to the at least one computing device 120. In other words, for example, at least one material-property signal indicating at least one property (e.g., the one or more constituent values) of the measured portions of the material may be transmitted to the at least one computing device 120 via a suitable communication network or a sidelink (e.g., device-to-device communication). The analyzer 140 may read material flow in the conveyor 150. In some embodiments, the analyzer 140 may comprise at least one sensor (e.g., analyzing sensor) that measures at least one property (e.g., measured quantities of at least one constituent) of the material on the conveyor 150. For example, when the material on the conveyor 150 is coal, the analyzer 140 may perform full analysis on the coal and provide measured quantities (or ratio) of ash, potassium, calcium, sodium, phosphorous, chlorine phosphorous, calorific value, sulfur, iron, moisture, and/or other constituent(s) of the coal. In some embodiments, the analyzer 140 may be an existing analyzer such as COALSCAN™ 9500X analyzer.

The at least one computing device 120 may use a collection device model to track each load through the collection device 130 and estimate when the material (e.g., coal, mineral, metal) reaches the analyzer 140. For example, the at least one computing device 120 may estimate movement of the portions of the material deposited into the collection device 130, and assess when the deposited material would reach at the analyzer 140, as illustrated above and elsewhere in the present disclosure. Then, the estimations of at least one property (e.g., an estimated ash value) may be associated with each measured portion of the material by the analyzer 140. In some embodiments, the at least one computing device 120 may associate the estimations of at least one property with each measured portion of the material according to the estimated movement of the material within the collection device 130 and/or estimated movement from the collection device 130 to the analyzer 140. The estimations of at least one property of the measured material may be provided to the at least one computing device 120 via at least one material-property signal indicating at least one property of the measured material over a suitable network or a sidelink. There may also be a mixing factor happening in the collection device 130. The mixing factor may be detected and accordingly the estimations of at least one property of the measured material may be corrected by the at least one computing device 120. In some embodiments, the mixing factor may be assessed using a radio-frequency identification (RFID) technology. In some embodiments, RFID technology is used to evaluate the material flows in the collection device 130, mixing factor in the collection device 130 and/or dependency on height in the collection device 130 and speed of the material in the collection device 130, in order to track the respective portions of the material deposited into the collection device 130.

Then, the at least one computing device 120 may associate the estimations or measurements of at least one property of the measured material with one or more portions of the material associated with respective pickup events at the stockpile 170. In this way, the at least one computing device 120 may associate the estimations or measurements of the at least one property of the measured material with respective pickup events at the stockpile 170. Put another way, the at least one computing device 120 may determine or estimate the at least one property of the portions of the material associated with respective pickup events at the stockpile 170.

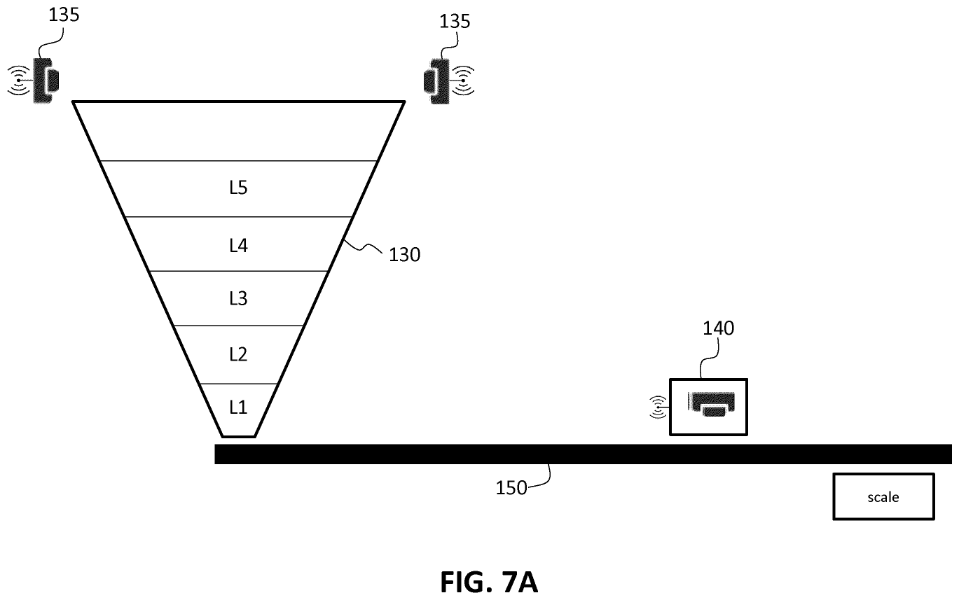

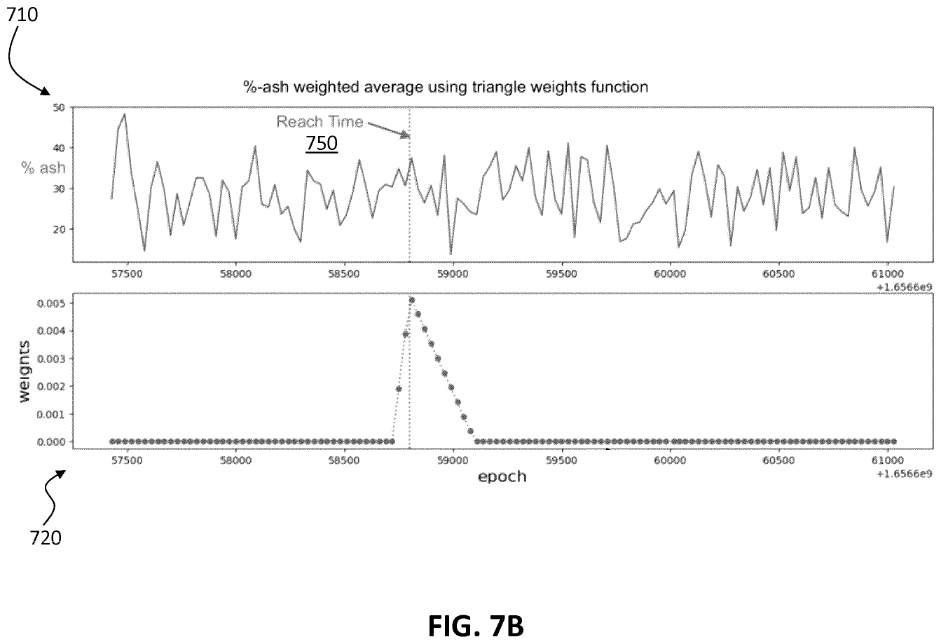

FIG. 7A is an schematic diagram of an example collection device 130, an example analyzer 140, and an example conveyor 150 in the system 100, in accordance with embodiments of the present disclosure. With reference to FIG. 7A, one or more output signals from one or more sensors 135 (e.g., deposit detection sensors) the collection device 130 enable tracking of the portions of the material deposited into the collection device 130. It should be noted that in some embodiments, the bulk material handlers 160 may comprise one or more deposit detection sensors that enables tracking of the respective portions of the material within the collection device 130.

The at least one computing device 120 may assume a plug flow model, e.g., first in, first out, for the loads L1 to L5, deposited into the collection device 130, while other models may be used. The material in the center of the collection device 130, e.g., hopper, may flow faster than the sides. As a result, there may be a mixing factor on each load (e.g., respective portions of the material deposited into the collection device 130). The higher the hopper height, the more mixing may be expected on each load by the time respective portions of the material deposited into the collection device 130 reach the analyzer 140. The at least one computing device 120 may correct the estimations of at least one property of the measured material for these factors when associating the estimations of the measurements of at least one property of the measured material with at least some of the pickup events at the stockpile 170 (e.g., assigning ash readings to respective load associated with respective pickup events). The at least one computing device 120 may also use any collection retention model, collection device, e.g., hopper, level measurements, apron feeder frequency, geometry of the collection device 130, and/or scales in order to determine the time that a portion of the material deposited into the collection device 130 reaches the analyzer 140. The times that portions of the material deposited into the collection device 130 travel within the collection device 130 may be typically 5 to 20 minutes, and the times that the portions of the material came out of the collection device 130 convey on the conveyor 150 to the analyzer 140 may be typically 2-3 minutes. These times may also be measured and communicated to the at least one computing device 120 using at least one signal.

Relying on the accuracy of the measurements of the analyzer 140, and the estimated movement of the portions of the material from the collection device 130 to the analyzer 140, the at least one computing device 120 may assign constituent value readings (e.g., measured quantities of at least one constituent of the measured material) to each specific load when the material reaches at the analyzer 140. The analyzer 140 may provide a rolling average of the measurements in a predetermined time interval, e.g. less than 1 minute, or less than 30 seconds. The at least one computing device 120 may use the estimation of the bucket load volume of the bulk material handlers 160, the volume flow rate of the collection device 130, the speed of the conveyor 150, and/or the conveyor speed frequency, in order to define the length of time a load will be analyzed through the analyzer 140.

In some embodiments, the at least one computing device 120 may use at least 3, or 4-6, subsequent readings to statically estimate constituent values of a load (e.g., statistically estimate quantities of at least one constituent of the measured material). For example, the at least one computing device 120 may, in response to at least measurement(s) of the at least one property of portions of the material, estimate (or obtain the estimations of) the at least one property of the measured material according to a weight function and a plurality of measurements of the quantities of at least one constituent of the measured material. Put another way, the weighted average for a plurality of measurements of the quantities of at least one constituent of the measured material may be used as the estimation(s) of the at least one property of the measurement material (e.g., the estimation(s) of the quantities of the at least one constituent of the measured material).

FIG. 7B illustrates an example of weighting measurements of ash in the measured coal, in accordance with embodiments of the present disclosure. Referring to FIG. 7B, the top graph 710 may be a graph for quantity (e.g., in percentage) of ash in the measured coal over time. The bottom graph 720 may be a graph for a triangular weight function used for weighting measurements of ash in the measured coal over time. While a triangular weight function is illustrated in FIG. 7B, it should be noted that one or more other weight functions (e.g., gaussian weight function) may be used for estimations of the at least one property of the measure material. In the bottom graph 720, each of the weights to be applied to each of the measurements of ash quantity in the measured portions of the coal is illustrated as a dot (●).

In some embodiments, the at least one computing device 120 may, in response to the plurality of measurements of ash quantity in the measured portions of the coal or in response to at least one material-property signal of the measured portions of the material, apply the weights shown in the graph 720 to respective measurements shown in the graph 710 of ash quantity in the measured portions of the coal (e.g., readings over time of the ash quantity values in the portions of the material scanned by the at least one analyzer 140). Then, the at least one computing device 120 may acquire the weighted average of a plurality of measurements of ash quantity in the measured material, and this weighted average may be used or considered as the estimation of the ash quantity in the portion of the coal measured by the at least one analyzer 140 at the reach time 750. In other words, when a deposit of material is estimated to have reached the at least one analyzer 140 at the reach time 750, the ash content of that deposit may be estimated by applying the weights shown in the graph 720 to respective measurements of ash quantity at different times as shown in FIG. 7B.

In some embodiments, the at least one computing device 120 may also correct the readings, for example based on one or more mixing factors in the collection device 130.

In some embodiments, in response to at least measurement of the at least one property of the material, the at least one computing device 120 may associate respective estimations of the at least one property of the measured or analyzed material (e.g., respective portions of the material measured or analyzed by the analyzer 140) with respective regions of a plurality of regions of the material. The respective regions may be, be defined according to, or comprise at least some of the stockpiles 170 and/or at least some of the zones (e.g., zone 211, 212, 213, 571, 572, 573, 671, 672, and/or 673) of the stockpiles 170. For example, the at least one computing device 120 may identify each load that is being measured or analyzed by the analyzer 140 and trace the load back to the corresponding stockpile 170 and/or zone of origin (e.g., zone 571, 572, 573, 671, 672, and/or 673 where each load is picked up) or other region. The at least one computing device 120 may then assign a value for each constituent of interest to a detected load, after being measured or analyzed by the analyzer 140, and associate this measurement with a specific stockpile 170 zone (e.g., zone 211, 212, 213, 571, 572, 573, 671, 672, and/or 673) of the stockpiles 170 or other region, and/or time of the corresponding pickup event.

In some embodiments, in response to at least associating estimations of the at least one property with the respective regions, the at least one computing device 120 may identify at least one respective location of at least one future pickup event. The at least one respective location of the at least one future pickup event may comprise at least one respective region of the plurality of regions. In some embodiments, the at least one computing device 120 may identify the at least one respective location of the at least one future pickup event in response to at least one objective for a product comprising the respective portions of the material associated with the plurality of pickup events. The at least one objective may comprise at least one of minimizing a variability of a constituent of the product over time, minimizing a variability of relative ash content of the product over time, obtaining a target calorific level of the product, or ensuring minimal deviation from a target level of ash content of the product.

In some embodiments, in response to at least associating the respective estimations of the at least one property with the respective regions, the at least one computing device 120 may evaluate multiple possible combinations of loads based on the current constituent level estimation of the zones of the stockpiles 170, e.g., the current constituent (ash) content, the current blend ratios and/or the blend target constituent (ash). The possible combinations may be ranked based on anticipated impact related to the desired quantities of constituents of the material, e.g., obtaining target calorific level, minimizing the ash variability, and/or ensuring minimal deviation from the target ash. The at least one computing device 120 may recalculate the available options from time to time and adjust the recommendations based on the current measurements.

In some embodiments, such options may be identified according to desired ratios of pickups from different stockpiles. For example, desired ratios may involve making 10% of pickups from one specific stockpile, 25% of pickups from another specific stockpile, 30% of pickups from another specific stockpile, and 35% of pickups from another specific stockpile. In such embodiments, options each involving different zones from each such stockpile may be identified. For example, if each such stockpile has three zones, one option may be to make pickups from the left-most zone of each stockpile, another option may be to make pickups from the middle zone of the first stockpile and the left-most zones of each other stockpile, another option may be to make pickups from the right-most zone of the first stockpile and the left-most zones of each other stockpile, and so on. In such embodiments, such options may be ranked to identify an option that most closely appears to satisfy one or more objectives for a product comprising the respective portions of the material associated with a plurality of pickup events.

In some embodiments, in response to at least identifying the at least one respective location of the at least one future pickup event, the at least one computing device 120 may transmit, to for example at least one of the material handlers 160, at least one future-pickup-location signal indicating at least the at least one respective location of the at least one future pickup event.

In some embodiments, there may be a system and method for increasing yield in material production from at least one stockpile 170, whereby each stockpile 170 includes a plurality of zones (e.g., zone 211, 212, 213, 571, 572, 573, 671, 672, and/or 673), and each zone has a different constituent content. The method of increasing yield in material production may comprise:
a) determining an initial constituent content value for each zone of each stockpile 170 of material;
b) using a processor (e.g., processor of the at least one computing device 120) executing instructions stored on non-transitory memory (e.g., memory of the at least one computing device 120) configured to direct at least one bulk material handler 160 to collect, transport and dump loads of material from the plurality of zones of the plurality of stockpiles 170 to a collection device 130 based on the constituent content value of each zone of each stockpile for increasing yield of a final product;
c) detecting a time that each load of material enters the collection device 130, e.g., when each load is collected from the stockpile 170 and dumped in the collection device 130;
d) determining when each load of material passes an analyzer 140 based on the time each load of material entered the collection device 130;
e) analyzing the constituent content of each load of material with the analyzer 140;
f) updating the constituent content value of at least one of the zones based on results of the analyzer 140; and
g) repeating steps b) to f) based on the updated constituent content value of each zone of each stockpile 170 of material.

Step b) may include providing recommendations to bulk material handlers 160 on where they need to go to load the next buckets to reach the blending goal, e.g., minimize ash variability.

The recommendation may simulate multiple possible scenarios and provide recommendations considering: the target function, e.g., minimize ash variability, and other constraints, e.g., safety, volumes and locations of stockpiles.

The system may be used to achieve a desired yield for a desired calorific value of the coal. For example, initial constituent, i.e., calorific value, of each zone of each stockpile 170 may be determined, e.g., by independent testing of each zone or each stockpile or by historic analysis based on previous system measurements. The at least one computing device 120 may then direct the bulk material handlers 160 to a sequence of zones of stockpiles 170, based on their current calorific value, to achieve the desired calorific value of the processed coal. As more loads of coal are processed, the calorific value for each zone of each stockpile 170 may be updated by the at least one computing device 120 utilizing the aforementioned system. Other factors may also come into play, such as time to each bulk material handler 160 to travel to the various stockpiles 170, desire to use aging stockpiles 170, etc.

In some embodiments, there may be a system and method of increasing yield in material production from at least one stockpile 170 of the material (e.g., coal, mineral, metal, etc.), whereby each stockpile 170 may include a plurality of zones, e.g., zone 211, 212, 213, 571, 572, 573, 671, 672, and/or 673, each zone may have a different constituent content. The method of increasing yield in material production may comprise:
a) determining an constituent content value for each zone of each stockpile 170 of material;
b) using a processor (e.g., processor of the at least one computing device 120) executing instructions stored on non-transitory memory (e.g., memory of the at least one computing device 120) configured to direct at least one bulk material handler 160 to collect, transport and dump loads of material from the plurality of zones of the plurality of stockpiles 170 to a collection device 130 based on the constituent content value of each zone of each stockpile for increasing yield of a final product;
c) detecting a time that each load of material enters the collection device 130, e.g., when coal is collected from each zone of each stockpile 170 and dumped in the collection device 130;
d) determining when each load of material passes an analyzer 140 based on the time each load of material entered the collection device 130, which may include how the material flows inside the collection device 130, including its retention time and mixing factor;
e) analyzing the constituent content of each load of material (e.g., coal) with the analyzer 140;
f) updating the constituent content value of at least one of the zones based on results of the analyzer 140; and
g) repeating steps b) to e) based on the updated constituent content value of each zone of each stockpile 170 of the material (e.g., coal).

Accordingly, the present disclosure may be particularly useful with a plurality of different zones in each stockpile 170, and with a method and system that frequently updates one or more estimations at least one property of the material (e.g., the ash content value) for each zone of each stockpile 170.

The at least one computing device 120 may evaluate multiple possible combinations of loads considering the current ash estimation of the zones of the stockpiles 170, the current blend ratios and/or the blend target constituent, e.g., ash. The possible combinations may be ranked based on anticipated impact on minimizing the ash variability and ensuring minimal deviation from the target ash. The at least one computing device 120 may recalculate the available options from time to time and adjust the recommendations based on the current measurements.

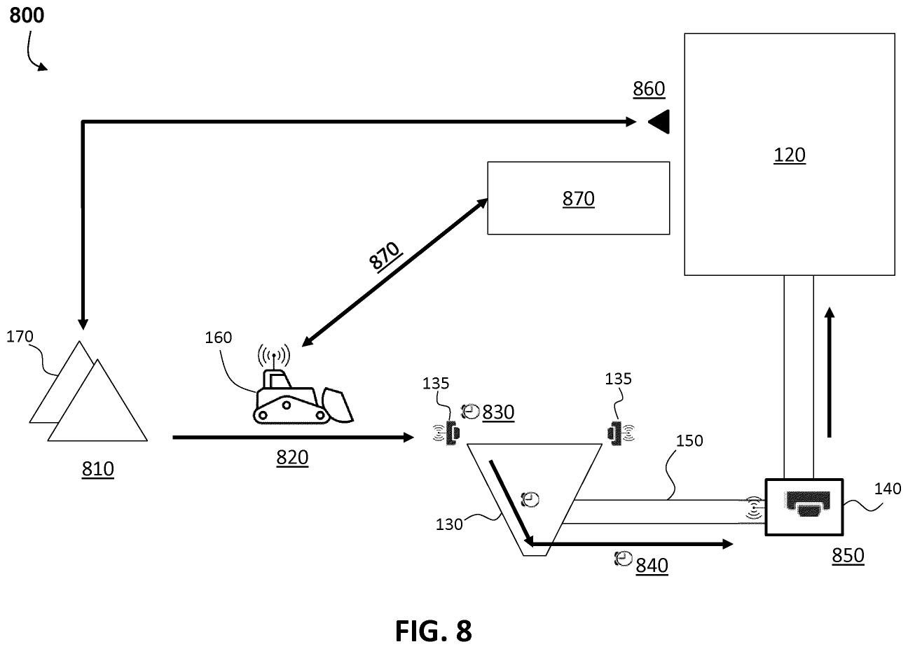

For example, with reference to FIG. 8, to increase the yield of the material at the CWP 110, the at least one computing device 120 may reduce the variance of the ash content of the loads. There may be a system and method of reducing ash variance in coal production at a plurality of stockpiles 170 of coal, each stockpile 170 may include a plurality of zones, e.g., zone 211, 212, 213, 571, 572, 573, 671, 672, and/or 673, and each zone may have a different ash content. The method 800 of reducing ash variance in coal production may comprise:
a) at step 810 determining an ash content value for each zone of each stockpile 170 of coal;
b) at step 820 using a controller processor executing instructions stored on non-transitory memory configured to direct at least one bulk material handler 160 to collect, transport and dump loads of coal from the plurality of zones of the plurality of stockpiles 170 to a collection device 130 based on the ash content value of each zone of each stockpile for reducing the ash content variance of a final product;
c) at step 830 detecting a time that each load of coal enters the collection device 130, which may include location and time of the loading from, for example each zone of each stockpile 170 (e.g., zone 211, 212, 213, 571, 572, 573, 671, 672, and/or 673);
d) at step 840 determining when each load of coal passes an ash analyzer 140 based on the time each load of coal entered the collection device 130, which may include a model to define how material flows and mixes inside the collection device 130;
e) at step 850 analyzing the ash content of each load of coal with the ash analyzer 140;
f) at step 860 updating the ash content value of at least one of the zones based on results of the ash analyzer; and
g) at step 870 repeating step b) to f) based on the updated ash content value of each zone of each stockpile 170 of coal. Step 870 may include recommendations provided to the bulk material handlers 160 in step b), indicating the next best loads to achieve the target function, e.g., minimize ash variability.

It should be noted that there may be a natural delay in material flowing from the stockpile 170 to the analyzer 140, e.g., overall 20-30 minutes of expected lag time. Since it is not possible to eliminate the time delay based on the natural process configuration and systems synchronization, it is necessary to explore alternative options to minimize the lag time.

The at least one computing device 120 may also be configured to provide the anticipated constituent values for each load using one or more neural networks, i.e., artificial intelligence, that evaluates the constituent values from previous measurements from a specific stockpile 170 and zone of the stockpile 170 (e.g., zone 211, 212, 213, 571, 572, 573, 671, 672, and/or 673) and forecast the next bucket values.

In some embodiments, any inconsistencies that are introduced in the process of facilitating movement of the material in at least one stockpile 170 may be managed by the at least one computing device 120 within error margins.

There may be correlation between ash levels in subsequent loads for both single and multi-seam runs. Therefore, ash values may be forecasted in scenarios with single seam, multi seam and mixed. Accordingly, in some embodiments, the at least one computing device 120 may include a neural network that may be used to forecast the expected ash value of a new load, when it is dumped at the collection device 130, based on past values from the same stockpile 170 and zone of origin (e.g., zone 211, 212, 213, 571, 572, 573, 671, 672, and/or 673).

One or more steps of the embodiment methods illustrated above and elsewhere in the present disclosure may be performed in real time by one or more devices in the system 100, for example at least one of the at least one computing device 120, the at least one collection device 130, the at least one analyzer 140, the at least one conveyor 150, or the at least one bulk material handler 160. For example, the at least one analyzer 140 may, in real time, measure at least one property of respective portions of the material associated with at least some of the pickup events, and transmit, in real time, to the at least one computing device 120, at least one material-property signal indicating the at least one property. After receiving or in response to the at least one material-property signal, the at least one computing device 120 may, in real time, associate respective estimations of the measurements of the at least one property with the at least one property with respective regions of the material, and may identify, in real time, at least one respective location of at least one future pickup event, and may transmit, in real time, to the at least one bulk material handler 160, at least one future-pickup-location signal indicating at least the at least one respective location of the at least one future pickup event. It should be noted that, in the present disclosure, ‘in real time’ may mean near real time, immediately, and/or in a short period of time that does not delay any process of facilitating movement of material in the at least one stockpile 170.

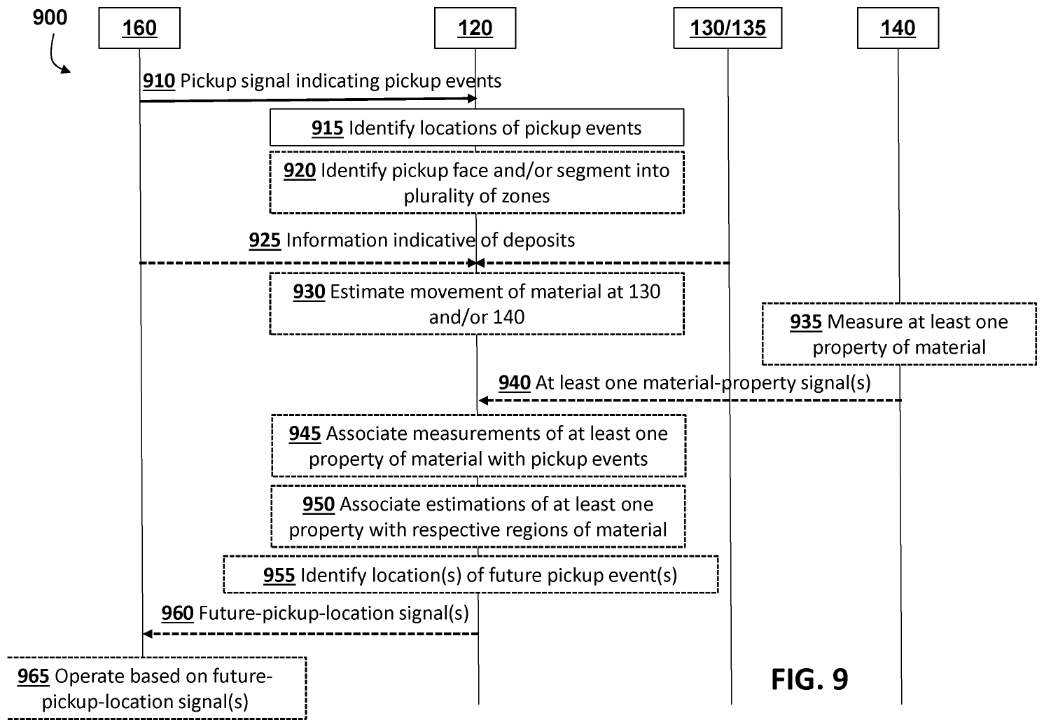

FIG. 9 illustrates an example procedure 900 for facilitating movement of material from at least one stockpile (e.g., at least one stockpile 170) comprising the material, in accordance with embodiments of the present disclosure. In some embodiments, the material may comprise coal. In some embodiments, the material may comprise at least one mineral. In some embodiments, the material may comprise metal.

At step 910, at least one bulk material handler 160 may transmit, to at least one computing device 120, at least one pickup signal indicating at least a plurality of pickup events.

Each pickup event of the plurality of pickup events may be associated with a respective portion of the material.

At step 915, in response to at least the at least one pickup signal received at step 910, the at least one computing device 120 may identify at least respective locations of the pickup events.

At step 920, in some embodiments, the at least one computing device 120 may identify at least a respective pickup face of one or more stockpiles of the at least one stockpile of the material in response to, at least, at least some of the locations of the pickup events. However, it should be noted that in some embodiments, the at least one computing device 120 may not identify at least a respective pickup face of one or more stockpiles of the at least one stockpile of the material.

In some embodiments, the at least one computing device 120 may segment the respective pickup face of each stockpile of the one or more stockpiles into a respective plurality of zones. In some embodiments, the at least one computing device 120 may segment each stockpile of the one or more stockpiles into a respective plurality of zones. In some embodiments where the respective pickup face of the one or more stockpiles is not required to be identified, the at least one computing device 120 may segment each stockpile of one or more stockpiles of the at least one stockpile into a respective plurality of zones.

In some embodiments, step 920 may be an optional step.

At step 925, in response to at least respective deposits, in at least one deposit location, of the respective portions of the material associated with at least some of the pickup events, at least one of the at least one bulk material hander 160, at least one collection device 130, or one or more sensors 135 may transmit, to the at least one computing device 120, at least one deposit signal indicative of at least the respective deposits. In other words, in response to the at least respective deposits, the at least one computing device 120 may obtain information indicative of at least the respective deposits.

In some embodiments, the at least one collection device 130 may comprise a hopper. In some embodiments, the at least one collection device 130 may comprise a breaker. In some embodiments, the at least one collection device 130 may comprise a silo.

In some embodiments, the one or more sensors 135 may be part of the collection device 130 or provided proximate to the collection device 130. In some embodiments, step 925 may be an optional step.

At step 930, in response to at least the information indicative of at least the respective deposits, the at least one computing device 120 may estimate movement of the respective portions of the material associated with the at least some of the pickup events, within the at least one collection device 130. The at least one collection device 130 may be positioned to receive, from the at least one deposit location, the respective portions of the material associated with the at least some of the pickup events.

In some embodiments, step 930 may be an optional step.

At step 935, at least one analyzer 140 may measure at least one property of respective portions of the material associated with at least some of the pickup events. In some embodiments, at least one sensor (e.g., analyzing sensor) of the at least one analyzer 140 may measure the at least one property of the respective portions of the material associated with at least some of the pickup events.

In some embodiments, the at least one property may comprise measured quantities of at least one constituent of the respective portions of the material associated with the at least some of the pickup events. In some embodiments, the at least one constituent may comprise ash. In some embodiments, the at least one constituent may comprise calcium. In some embodiments, the at least one constituent may comprise sulfur.

In some embodiments, step 935 may be an optional step.

At step 940, the at least one analyzer 140 may transmit, to the at least one computing device 120, at least one material-property signal indicating the at least one property of the respective portions of the material associated with at least some of the pickup events (e.g., the at least one property measured at step 935).

In some embodiments, step 940 may be an optional step.

At step 945, the at least one computing device 120 may associate measurements of the at least one property with the respective portions of the material associated with the at least some of the pickup events. In some embodiments, the at least one computing device 120 may associate the measurements of the at least one property with the respective portions of the material according to at least the estimated movement, of the respective portions of the material associated with the at least some of the pickup events, within the at least one collection device 130. In some embodiments, the movement, of the respective portions of the material associated with the at least some of the pickup events, within the at least one collection device 130 may be estimated according to at least measurements of respective volumes of the material associated with the at least some of the pickup events. In some embodiments, the movement, of the respective portions of the material associated with the at least some of the pickup events, within the at least one collection device 130 may be estimated according to at least measurements of depth height of the material in the at least one collection device 130. In some embodiments, the at least one computing device 120 may associate the measurements of the at least one property with the respective portions of the material according to according to at least measurements, by for example at least one volume sensor of the the at least one collection device 130, of the respective volumes of the material associated with the at least some of the pickup events. In some embodiments, the at least one computing device 120 may associate the measurements of the at least one property with the respective portions of the material according to at least measurements, by for example at least one height sensor of the at least one collection device 130, of the respective height of the material associated with the at least some of the pickup events.

In some embodiments, step 945 may be an optional step.

At step 950, in response to at least measurement of the at least one property of the respective portions of the material associated with the at least some of the pickup events, the at least one computing device 120 may associate respective estimations of the at least one property with respective regions of a plurality of regions of the material. In some embodiments, at least some of the regions of the plurality of regions may be respective ones of the at least one stockpile 170. In some embodiments, at least some of the regions of the plurality of regions may be respective ones of the zones (e.g., zone 211, 212, 213, 571, 572, 573, 671, 672, and/or 673). In some embodiments, step 950 may be an optional step.

At step 955, in response to at least associating the respective estimations of the at least one property with the respective regions, the at least one computing device 120 may identify at least one respective location of at least one future pickup event. In some embodiments, the at least one respective location of the at least one future pickup event may comprise at least one respective region of the plurality of regions.

In some embodiments, the at least one computing device 120 may identify the at least one respective location of the at least one future pickup event in response to at least one objective for a product comprising the respective portions of the material associated with the plurality of pickup events. In some embodiments, the at least one objective for the product may comprise minimizing a variability of a constituent of the product over time. In some embodiments, the at least one objective for the product may comprise minimizing a variability of relative ash content of the product over time. In some embodiments, the at least one objective for the product may comprise obtaining a target calorific level of the product. In some embodiments, the at least one objective for the product may comprise ensuring minimal deviation from a target level of ash content of the product.

In some embodiments, step 955 may be an optional step.

At step 960, in response to at least identifying the at least one respective location of the at least one future pickup event, the at least one computing device 120 may transmit, to the at least one handler 160, at least one future-pickup-location signal indicating at least the at least one respective location of the at least one future pickup event. In some embodiments, the at least one computing device 120 may transmit, to the at least one handler 160, the at least one future- pickup-location signal immediately after identifying the at least one respective location of the at least one future pickup event.

In some embodiments, step 960 may be an optional step.

At step 965, in response to at least the at least one future-pickup-location signal received from the at least one computing device 120, the at least one material handler 160 may operate according to the at least one respective location of the at least one future pickup event indicated in the at least one future-pickup-location signal.

For example, in some embodiments, the at least one material handler 160 may move to the at least one respective location of the at least one future pickup event as is indicated in the at least one future-pickup-location signal. In response to moving to the at least one respective location of the at least one future pickup event, the at least one material handler 160 may pick up at least one future portion of the material at the at least one respective location of the at least one future pickup event. In response to picking up the at least one future portion of the material, the at least one material handler 160 may transmit at least one future pickup signal indicating at least the at least one future pickup event associated with the at least one future portion of the material.

For example, in some embodiments, the at least one material handler 160 may present the at least one respective location of the at least one future pickup event. In this case, the at least one handler 160 may comprise at least one display (e.g., monitor, screen) to present the at least one respective location of the at least one future pickup event.

In some embodiments, step 965 may be an optional step.

Although FIG. 9 illustrates transmitting and receiving data and signals directly between the at least one computing device 120, the at least one collection device 130, the one or more sensors 135, the at least one analyzer 140, and/or the at least bulk material hander 160, in some embodiments, such data and signals may be transmitted indirectly in some embodiments, for example using a suitable network. It should however be noted that in some embodiments, such data and signals may be directly received and transmitted between the devices for example using device-to-device communication technologies.

FIG. 10 illustrates an example of at least one computing device 120, at least one collection device 130, at least one analyzer 140, and at least one bulk material handler 160 communicating with each other in the system 100, in accordance with embodiments of the present disclosure. The embodiment shown in FIG. 10 includes one computing device 120, one collection device 130, one analyzer 140, and one bulk material handler 160, but some other embodiments may include a plurality of computing devices 120, a plurality of collection devices 130, a plurality of analyzers 140, and/or a plurality of bulk material handlers 160.

The computing device 120, the collection device 130, the one analyzer 140, and/or the a bulk material handler 160 may be used and/or operated in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

In some embodiments, any of the computing device 120, the collection device 130, the analyzer 140, and/or the bulk material handler 160 may represent any suitable device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, an IoT device, an industrial device, a server, a server device, or apparatus (e.g. communication module, modem, or chip) in the forgoing devices, among other possibilities. Any of the at least one computing device 120, the at least one collection device 130, the at least one analyzer 140, and/or the at least one bulk material handler 160 may be referred to using other terms.

In some embodiments, the computing device 120 may comprise at least one of at least one processor 121, at least one memory 122, at least one transmitter 123, or at least one receiver 124. In some embodiments, the at least one processor 121 may include at least one machine learning (ML) module 125.

The at least one processor 121 may be performing one or more operations including those related to facilitating movement of material in at least one stockpile as illustrated above and elsewhere in the present disclosure. The at least one processor 121 may be executing one or more instructions stored in the at least one memory 122 including those related to facilitating movement of material in at least one stockpile as illustrated above and elsewhere in the present disclosure.

In some embodiments, one or more of the at least one processor 121 may comprise one or more ML modules 125. The one or more ML modules 125 may be implemented by the at least one processor 121 and therefore the one or more ML modules 125 is shown as being within the at least one processor 121 in FIG. 10. The one or more ML modules 125 execute one or more artificial intelligence or machine learning (AI/ML) algorithms to perform one or more artificial intelligence (AI)-enabled processes, e.g., AI-enabled operation to identify at least one respective location of at least one future pickup event, for example.

The one or more ML modules 125 may be implemented using an AI model. The term AI model may refer to a computer algorithm that is configured to accept defined input data and output defined inference data, in which parameters (e.g., weights) of the algorithm can be updated and optimized through training (e.g., using a training dataset, or using real-life collected data). An AI model may be implemented using one or more neural networks (e.g., including deep neural networks (DNN), recurrent neural networks (RNN), convolutional neural networks (CNN), and combinations thereof) and using various neural network architectures (e.g., autoencoders, generative adversarial networks, etc.). Various techniques may be used to train the AI model, in order to update and optimize its parameters.

Although not illustrated, the at least one processor 121 may form part of the at least one transmitter 123 and/or the at least one receiver 124. Although not illustrated, the at least one memory 122 may form part of the at least one processor 121.

The at least one processor 121, and the processing components of the at least one transmitter 123 and the at least one receiver 124 may each be implemented by the same or different one or more processors that are configured to execute instructions stored in a memory (e.g. in the at least one memory 122). Alternatively, some or all of the at least one processor 121, and the processing components of the at least one transmitter 123 and the at least one receiver 124 may be implemented using dedicated circuitry, such as a programmed field-programmable gate array (FPGA), a graphical processing unit (GPU), or an application-specific integrated circuit (ASIC).

The at least one memory 122 may store instructions and data used, generated, or collected by the computing device 120. For example, the at least one memory 122 may store software instructions or modules configured to implement some or all of the functionality and/or embodiments described herein and that are executed by the at least one processor 121. The at least one memory 122 may include any suitable volatile and/or non-volatile storage and retrieval device(s). Any suitable type of memory may be used, such as random access memory (RAM), read only memory (ROM), hard disk, a hard disk drive (HDD), a solid-state drive (SSD), optical disc, subscriber identity module (SIM) card, memory stick, secure digital (SD) memory card, on-processor cache, one or more other computer-readable and/or computer-writable storage media, a combination of two or more thereof, and/or the like.

The at least one transmitter 123 and the at least one receiver 124 may be coupled to one or more antennas (not shown in FIG. 10). One, some, or all of the antennas may alternatively be panels. The at least one transmitter 123 and the at least one receiver 124 may be integrated, e.g. as a transceiver. The transceiver is configured to modulate data or other content for transmission by at least one antenna or network interface controller (NIC). The transceiver is also configured to demodulate data or other content received by the at least one antenna. Each transceiver includes any suitable structure for generating signals for wireless or wired transmission and/or processing signals received wirelessly or by wire. Each antenna includes any suitable structure for transmitting and/or receiving wireless or wired signals.

In some embodiments, the collection device 130 may comprise at least one of at least one processor 131, at least one memory 132, at least one transmitter 133, at least one receiver 134, or one or more sensors 135.

The at least one processor 131, the at least one memory 132, the at least one transmitter 133, and the at least one receiver 134 may be similar to the at least one processor 121, the at least one memory 122, the at least one transmitter 123, and the at least one receiver 124 of the computing device 120, respectively, but the at least one processor 131, the at least one memory 132, the at least one transmitter 133, and the at least one receiver 134 are implemented for operations and functionalities of the collection device 130. In some embodiments, the at least one processor 131 may not include an ML module.

The one or more sensors 135 may be configured to detect at least the time and amount of respective deposited portions of the material (e.g., time and amount of each load deposited into the collection device 130) and/or detect the height of the material in the collection device 130. The one or more sensors 135 may be configured to assess mixing factor in the collection device 130. The one or more sensors 135 may comprise any one or more suitable sensors, for example but not limited to proximity sensors, gyroscope sensors, acoustic sensors, RFID sensors, laser imaging, detection, and ranging (LIDAR) sensors, level sensors, volume sensors, height sensors, and/or weight sensors.

In some embodiments, the analyzer 140 may comprise at least one of at least one of at least one processor 141, at least one memory 142, at least one transmitter 143, at least one receiver 124, or at least one sensor 145.

The at least one processor 141, the at least one memory 142, the at least one transmitter 143, and the at least one receiver 144 may be similar to the at least one processor 121, the at least one memory 122, the at least one transmitter 123, and the at least one receiver 124 of the computing device 120, respectively, but the at least one processor 141, the at least one memory 142, the at least one transmitter 143, and the at least one receiver 144 are implemented for operations and functionalities of the analyzer 140. In some embodiments, the at least one processor 141 may not include an ML module.

The at least one sensor 145 may be configured to measure at least one property of respective portions of the material (e.g., quantities of at least one constituent of the material) for example on the conveyor 150. The at least one sensor 145 may be material analyzing sensors and comprise any one or more suitable sensors, for example but not limited to material scanners, humidity sensors, and/or material composition sensors.

In some embodiments, the material handler 160 may comprise at least one of at least one of at least one processor 161, at least one memory 162, at least one transmitter 163, at least one receiver 164, at least one tracking module 165, at least one sensor 166, or at least one display 167.

The at least one processor 161, the at least one memory 162, the at least one transmitter 163, and the at least one receiver 164 may be similar to the at least one processor 121, the at least one memory 122, the at least one transmitter 123, and the at least one receiver 124 of the computing device 120, respectively, but the at least one processor 161, the at least one memory 162, the at least one transmitter 163, and the at least one receiver 164 are implemented for operations and functionalities of the bulk material handler 160. In some embodiments, the at least one processor 161 may not include an ML module.

The at least one tracking module 165 may be configured to acquire information indicative of location of the material handler 160. The information indicative of the material handler may be information of an absolute location of the material hander 160 (e.g., GPS coordinate) or information of a relative location in relation to a predetermine location in the system 100 (e.g., collection device 130). In some embodiments, some or all of the at least one tracking module 165 may be implemented as part of the at least one processor 161. In some embodiments, the at least one tracking module 165 may include any suitable units, apparatuses and/or devices, for example but not limited to proximity sensors, gyroscope sensors, GPS sensors and a laser imaging, detection, and ranging (LIDAR) sensors.

The at least one sensor 166 may be configured to detect if some of the material is picked up from at least one stockpile or at least one zone of one of the stockpiles, and/or if the picked-up material is deposited into, for example, the collection device 130. The at least one sensor 166 may include any suitable sensors, for example but not limited to position sensors (e.g., sensors that detect the position and/or movement of blade of the material handler 166), weight sensors, and/or gyroscope sensors.

The at least one display 167 may be configured to present the at least one respective location of the at least one future pickup event. The at least one display 167 may include any suitable display devices, for example but not limited to monitors, screens, and/or touch screens.

In some embodiments, the computing device 120, the collection device 130, the analyzer 140, and/or the bulk material handler 160 may further include one or more input/output devices (not shown in FIG. 10) or interfaces (such as a wired interface to the internet). The input/output devices permit interaction with a user or other devices in the network. Each input/output device includes any suitable structure for providing information to or receiving information from a user, such as a speaker, microphone, keypad, keyboard, display, or touch screen, including network interface communications.

In some embodiments, one or more components (e.g., processor, memory, transmitter, receiver, sensor, display, tracking module) illustrated above as part of the computing device 120, the collection device 130, the analyzer 140, and/or the bulk material handler 160 may be optional.

In some embodiments, the computing device 120, the collection device 130, the analyzer 140, and/or the bulk material handler 160 may be in communication with each other using a network 1000, which may include the Internet, a wide area network (WAN), a local area network (LAN), one or more other types of network, or a combination of two or more thereof. In some embodiments, the computing device 120, the collection device 130, the analyzer 140, and/or the bulk material handler 160 may be in communication with each other over an air interface. The air interface may include a number of components and associated parameters that collectively specify how a transmission is to be sent and/or received over the wireless medium. In some embodiments, the computing device 120, the collection device 130, the analyzer 140, and/or the bulk material handler 160 may be in communication with each other using one or more wired connections, one or more wireless connections, or a combination thereof, for example. It should be noted that while FIG. 10 illustrates that the computing device 120, the collection device 130, the analyzer 140, and the material handler 160 may communicate with each other via the network 1000, in some embodiments, at least some of the communications between these devices may be performed over a sidelink, for example using device-to-device (D2D) communication.

It should be noted that while methods, devices, and systems for facilitating movement of material in at least one stockpile are illustrated above and elsewhere in the present disclosure in the context of mining and/or coal washing process, a person skilled in the art would readily understand that the methods, devices, and systems of the present disclosure may be applicable in other industries, for example but not limited to agriculture, especially where there is a need for control at least one property of material for quality control, product optimization and/or minimization of environmental impact. Here, the material is not limited to coal, mineral, and/or metal but may include any type of material such as crops.

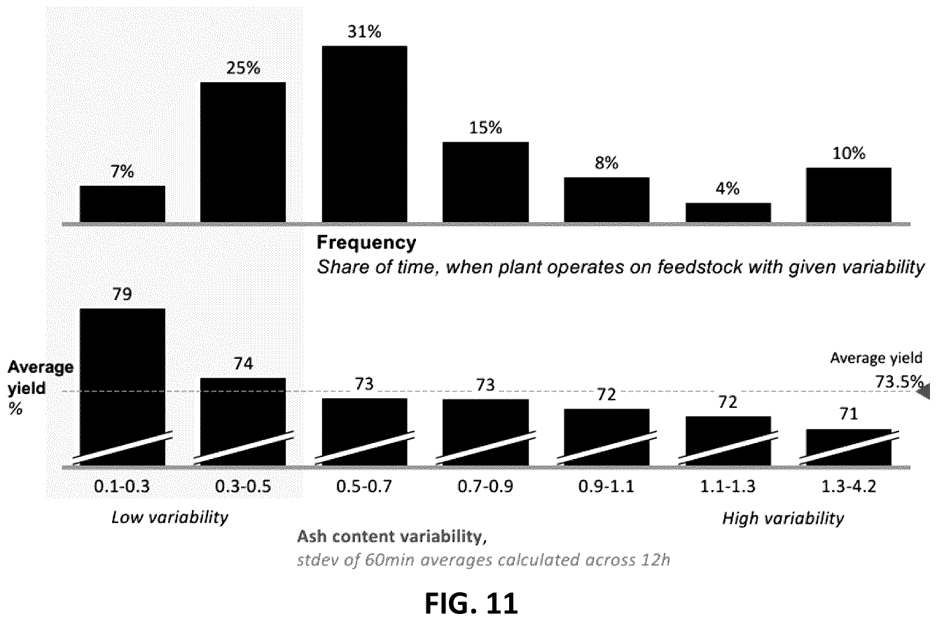

With reference to FIGS. 11-15, other constituent values, such as ash content, of the raw coal may also be monitored and controlled to increase yield and decrease cost and pollution of the processed coal.

FIG. 11 illustrates, according an example of one embodiment, the frequency at which a plant operates at one of a plurality of different ash variances, i.e. 1.3-4.2, 1.1-1.3, 0.9-1.1, 0.7-0.9, 0.5-0.7, 0.3-0.5 and 0.1-0.3, measured in standard deviations (stdev) of 60 minutes calculated across 12 hours. For example: 15% of the time the plant operates on feedstock with a stdev of ash content of 0.7-0.9 or 15% of the time 99.7% of the feed has an ash content 2.9 p.p. higher/lower than the “local” average.

Accordingly, a lower variability of ash content, e.g., 0.1-0.3, results in a much higher average yield, e.g., 79% instead of average yield of 73.5%, whereby eliminating instances of high variability may increase plant yield.

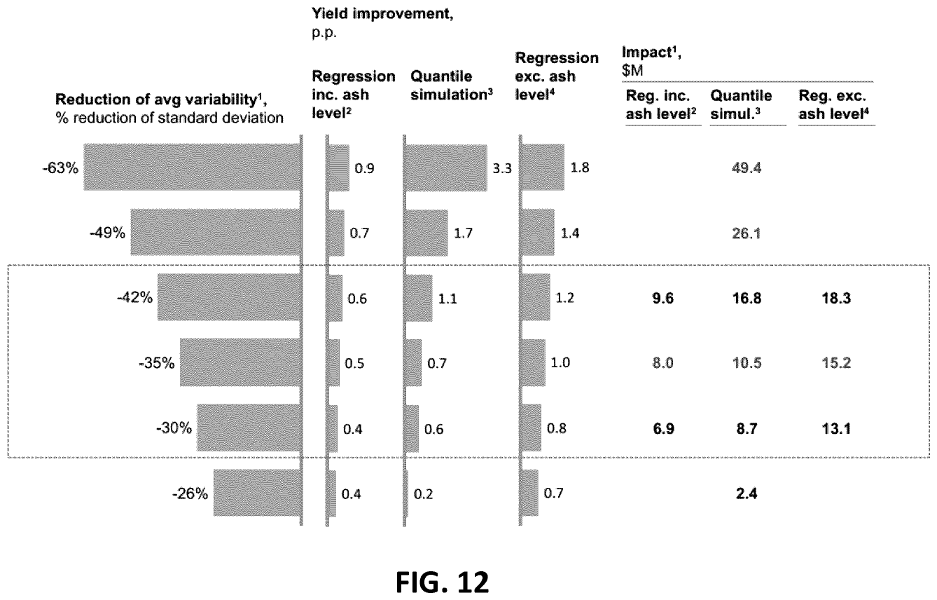

FIG. 12 illustrates a potential benefit of reducing the average variability in one embodiment. Accordingly, the reduction in the average variability of the ash content of 64% may result in a savings of $49.4 million, while even a reduction of over 49% may lead to a savings of $26.1 million. Even a reduction of between 30% and 42% of the variance in ash content may lead to a yield improvement of 0.6 to 1.1 percentage points (p.p.) and an annual savings of between $8.7 million and $16.8 million.

The impact is based on a sales case that assumes $15.1M per p.p. of yield increase. The regression including ash level is based on an empirical model predicting yield including data on hourly and daily feed ash level. The model evaluates historical data (more than 1 year) that compares actual levels of ash variability and its perceived yield for different products. The quantile simulation is based on average simulation for 7 ash content variability measures most correlated to yield, including: stdev of 60 min averages calculated across 12 h, stdev of 30 min averages calculated across 12 h, stdev of 10 min averages calculated across 12 h; stdev of 60 min averages calculated across 6 h; stdev of 30 min averages calculated across 6 h; stdev of 10 min averages calculated across 6 h; stdev of 2 min observations calculated across 8 h. The regression excluding ash level is based on an empirical model predicting yield including data on daily feed ash level but excluding data on hourly ash level.

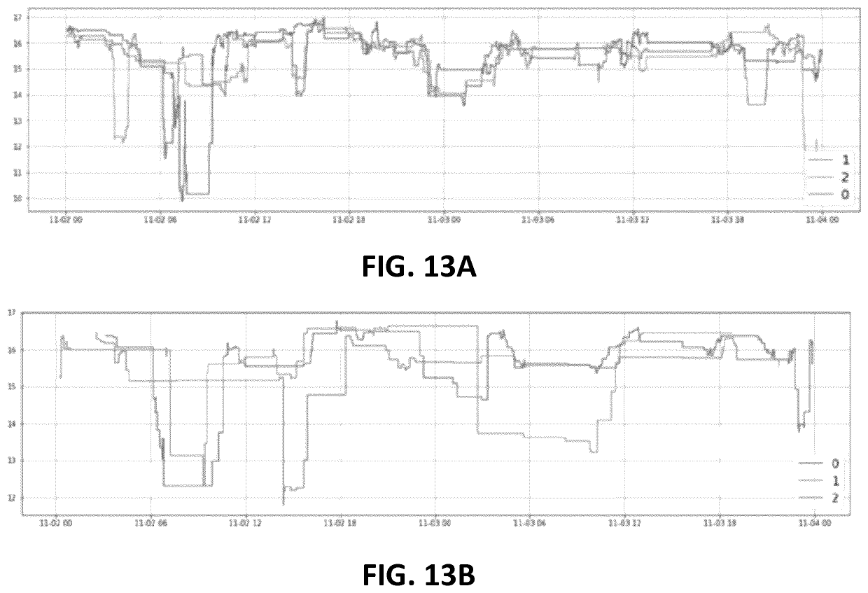

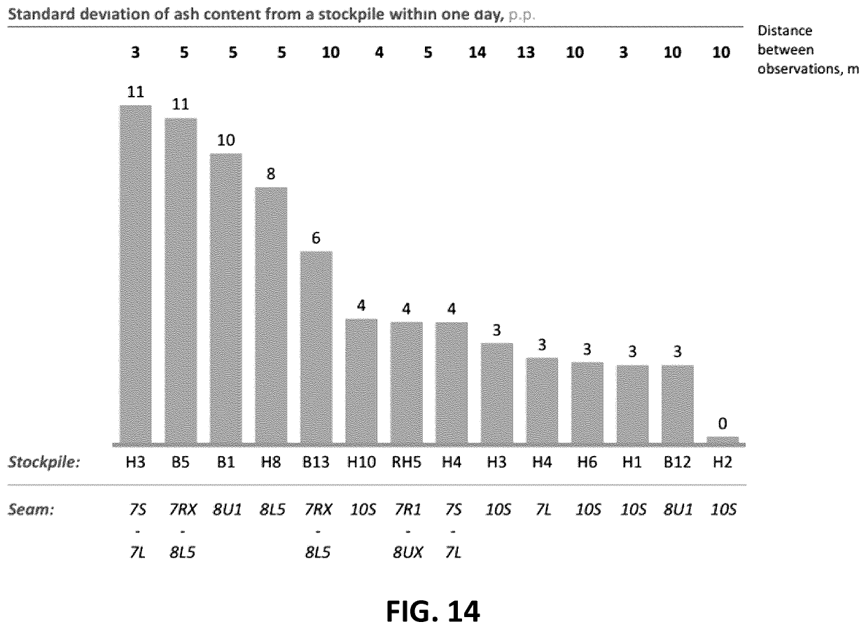

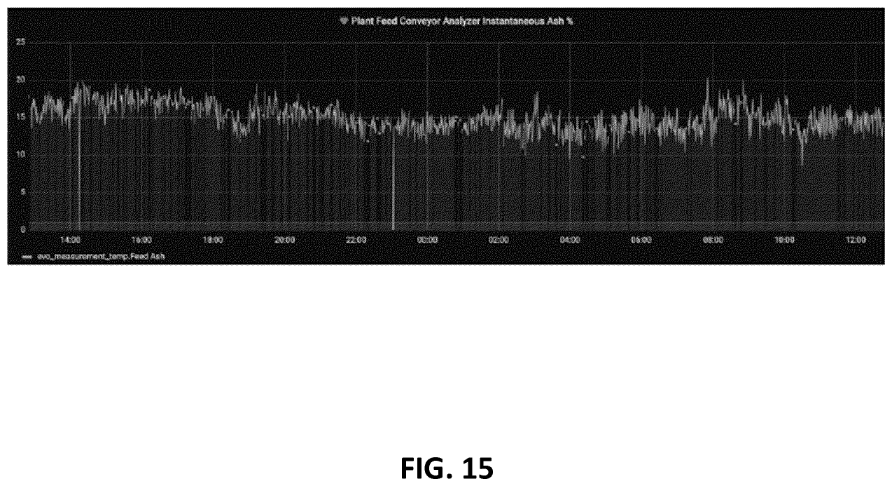

Unfortunately, each stockpile 170 contains coal with varying ash variability that is poorly spatially correlated, and may not be constant even during a single day or even a single hour. FIGS. 13A and 13B illustrate the variability in ash content over time for three different zones in two different stockpiles according to one embodiment. With reference to the example of FIG. 14, multiple measurements of ash content were taken within close proximity on a daily timeframe for a plurality of stockpiles, which illustrated that the level of ash variability is not consistent across stockpiles which is likely due to varying seam sources or changes in seam quality over time. FIG. 15 illustrates an example in which the ash content over time measured by the analyzer 140, illustrating the ability of the at least one computing device 120 of the present disclosure to maintain the variance of the ash content within a desired range, e.g., 12%-18%.

Some aspects of the present disclosure may provide a method of increasing yield in mineral production in a system comprising a plurality of stockpiles of mineral, each stockpile including a plurality of zones, each zone having a different constituent content, the method comprising:
a) determining a constituent content value for each zone of each stockpile of mineral;
b) using a controller processor executing instructions stored on non-transitory memory configured to direct at least one bulk material handler to collect, transport and dump loads of mineral from the plurality of zones of the plurality of stockpiles to a collection device based on the constituent content value of each zone of each stockpile for increasing yield of a final product;
c) detecting a time that each load of mineral is collected by the at least one bulk material handler at each zone and enters the collection device;
d) determining when each load of mineral passes an analyzer based on the time each load of mineral entered the collection device;
e) analyzing the constituent content of each load of mineral with the analyzer;
f) updating the constituent content value of at least one of the zones based on results of the analyzer; and
g) repeating steps b) to f) based on the updated constituent content value of each zone of each stockpile of mineral.

In some embodiments, step d) includes correcting for a mixing factor with the collection device. In some embodiments, step c) includes detecting a time and location that each load of mineral is loaded onto each bulk material handler from each stockpile. In some embodiments, the at least one bulk material handler comprises a plurality of bulk material handlers. In some embodiments, the mineral comprises coal, and the constituent is selected from the group consisting of ash, calcium and sulfur.

Some aspects of the present disclosure may provide a system for increasing yield in mineral production in a system comprising a plurality of stockpiles of mineral, each stockpile including a plurality of zones, each zone having a different constituent content, the method comprising:
a processor;
a non-transitory memory including computer instructions, which when executed by the processor:
   a) direct at least one bulk material handlers to collect, transport and dump loads of mineral from the plurality of zones of the plurality of stockpiles to a collection device based on a constituent content value of each zone of each stockpile for increasing yield of a final product;
   b) detect a time that each load of mineral is collected by the at least one bulk material handlers at each zone and enters the collection device;
   c) determine when each load of mineral passes an analyzer based on the time each load of mineral entered the collection device;
   d) update the constituent content value of at least one of the zones based on results of the analyzer; and
   e) repeating steps a) to d) based on the updated constituent content value of each zone of each stockpile of mineral.

Some aspects of the present disclosure may provide a method of reducing ash variance in coal production in a system comprising a plurality of stockpiles of coal, each stockpile including a plurality of zones, each zone having a different ash content, the method comprising:
a) determining an ash content value for each zone of each stockpile of coal;
b) using a controller processor executing instructions stored on non-transitory memory configured to direct at least one bulk material handlers to collect, transport and dump loads of coal from the plurality of zones of the plurality of stockpiles to a collection device based on the ash content value of each zone of each stockpile for reducing the ash variance of a final product;
c) detecting a time that each load of coal enters the collection device;
d) determining when each load of coal passes an ash analyzer based on the time each load of coal entered the collection device;
e) analyzing the ash content of each load of coal with an ash analyzer;
f) updating the ash content value of at least one of the zones based on results of the ash analyzer; and
g) repeating steps b) to f) based on the updated ash content value of each zone of each stockpile of coal.

Some aspects of the present disclosure may provide a system reducing ash variance in coal production in a system comprising a plurality of stockpiles of coal, each stockpile including a plurality of zones, each zone having a different ash content, the method comprising:
a processor;
a non-transitory memory including computer instructions, which when executed by the processor:
   a) direct at least one bulk material handlers to collect, transport and dump loads of coal from the plurality of zones of the plurality of stockpiles to a collection device based on the ash content value of each zone of each stockpile for reducing the ash variance of a final product;
   b) detect a time that each load of coal enters the collection device;
   c) determine when each load of coal passes an ash analyzer based on the time each load of coal entered the collection device;
   d) update the ash content value of at least one of the zones based on results of the ash analyzer; and
   e) repeating steps a) to d) based on the updated ash content value of each zone of each stockpile of coal.

The foregoing description of one or more example embodiments has been presented for the purposes of illustration and description. It is not intended to be exhaustive or to limit the invention to the precise form disclosed. Many modifications and variations are possible in light of the above teaching. It is intended that the scope of the disclosure be limited not by this detailed description.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

1. A method of facilitating movement of material from at least one stockpile comprising the material, the method comprising:
causing at least one computing device to receive at least one pickup signal indicating at least a plurality of pickup events, each pickup event of the plurality of pickup events associated with a respective portion of the material; and
causing the at least one computing device to, in response to at least the at least one pickup signal, identify at least respective locations of the pickup events.

2. The method of claim 1, further comprising causing the at least one computing device to identify at least a respective pickup face of one or more stockpiles of the at least one stockpile of the material in response to, at least, at least some of the locations of the pickup events.

3. The method of claim 2, further comprising causing the at least one computing device to segment the respective pickup face of each stockpile of the one or more stockpiles into a respective plurality of zones.

4. The method of claim 2, further comprising causing the at least one computing device to segment each stockpile of the one or more stockpiles into a respective plurality of zones.

5. The method of claim 1, further comprising causing the at least one computing device to segment each stockpile of one or more stockpiles of the at least one stockpile into a respective plurality of zones.

6. The method of any one of claims 1 to 5, further comprising causing the at least one computing device to receive at least one material-property signal indicating at least one property of the respective portions of the material associated with at least some of the pickup events.

7. The method of any one of claims 1 to 5, further comprising causing at least one sensor to measure at least one property of the respective portions of the material associated with at least some of the pickup events.

8. The method of claim 6 or 7, wherein the at least one property comprises measured quantities of at least one constituent of the respective portions of the material associated with the at least some of the pickup events.

9. The method of claim 8, wherein the at least one constituent comprises ash.

10. The method of claim 8 or 9, wherein the at least one constituent comprises calcium.

11. The method of claim 8, 9, or 10, wherein the at least one constituent comprises sulfur.

12. The method of any one of claims 6 to 11, further comprising causing the at least one computing device to, in response to at least measurement of the at least one property of the respective portions of the material associated with the at least some of the pickup events, associate respective estimations of the at least one property with respective regions of a plurality of regions of the material.

13. The method of claim 12, wherein at least some of the regions of the plurality of regions are respective ones of the at least one stockpile.

14. The method of claim 12 or 13, when dependent from claim 3, 4, or 5, wherein at least some of the regions of the plurality of regions are respective ones of the zones.

15. The method of claim 12, 13, or 14, further comprising causing the at least one computing device to, in response to at least associating the respective estimations of the at least one property with the respective regions, identify at least one respective location of at least one future pickup event.

16. The method of claim 15, wherein the at least one respective location of the at least one future pickup event comprises at least one respective region of the plurality of regions.

17. The method of claim 15 or 16, wherein causing the at least one computing device to identify the at least one respective location of the at least one future pickup event comprises causing the at least one computing device to identify the at least one respective location of the at least one future pickup event in response to at least one objective for a product comprising the respective portions of the material associated with the plurality of pickup events.

18. The method of claim 17, wherein the at least one objective for the product comprises minimizing a variability of a constituent of the product over time.

19. The method of claim 17, wherein the at least one objective for the product comprises minimizing a variability of relative ash content of the product over time.

20. The method of any one of claims 17 to 19, wherein the at least one objective for the product comprises obtaining a target calorific level of the product.

21. The method of any one of claims 17 to 20, wherein the at least one objective for the product comprises ensuring minimal deviation from a target level of ash content of the product.

22. The method of any one of claims 15 to 21, further comprising causing the at least one computing device to, in response to at least identifying the at least one respective location of the at least one future pickup event, transmit at least one future-pickup-location signal indicating at least the at least one respective location of the at least one future pickup event.

23. The method of claim 22, wherein causing the at least one computing device to transmit the at least one future-pickup-location signal comprises causing the at least one computing device to transmit the at least one future-pickup-location signal immediately after identifying the at least one respective location of the at least one future pickup event.

24. The method of claim 22 or 23, further comprising causing at least one material handler to, in response to at least the at least one future-pickup-location signal, operate according to the at least one respective location of the at least one future pickup event.

25. The method of claim 24, wherein causing the at least one material handler to operate according to the at least one respective location of the at least one future pickup event comprises causing the at least one material handler to move to the at least one respective location of the at least one future pickup event.

26. The method of claim 25, further comprising causing the at least one material handler to, in response to moving to the at least one respective location of the at least one future pickup event, pick up at least one future portion of the material at the at least one respective location of the at least one future pickup event.

27. The method of claim 26, further comprising causing the at least one material handler to, in response to picking up the at least one future portion of the material, transmit at least one future pickup signal indicating at least the at least one future pickup event associated with the at least one future portion of the material.

28. The method of any one of claims 23 to 27, wherein causing the at least one material handler to operate according to the at least one respective location of the at least one future pickup event comprises causing the at least one material handler to present the at least one respective location of the at least one future pickup event.

29. The method of any one of claims 6 to 28, further comprising causing the at least one computing device to associate measurements of the at least one property with the respective portions of the material associated with the at least some of the pickup events.

30. The method of any one of claims 6 to 29, further comprising causing the at least one computing device to, in response to at least respective deposits, in at least one deposit location, of the respective portions of the material associated with the at least some of the pickup events, obtain information indicative of at least the respective deposits.

31. The method of claim 30, further comprising causing the at least one computing device to, in response to at least the information indicative of at least the respective deposits, estimate movement, of the respective portions of the material associated with the at least some of the pickup events, within at least one collection device positioned to receive, from the at least one deposit location, the respective portions of the material associated with the at least some of the pickup events.

32. The method of claim 31, when dependent from claim 29, wherein causing the at least one computing device to associate the measurements of the at least one property with the one or more respective portions of the material comprises causing the at least one computing device to associate the measurements of the at least one property with the one or more respective portions of the material according to at least the estimated movement, of the respective portions of the material associated with the at least some of the pickup events, within the at least one collection device.

33. The method of claim 32, wherein causing the at least one computing device to associate the measurements of the at least one property with the one or more respective portions of the material comprises causing the at least one computing device to associate the measurements of the at least one property with the one or more respective portions of the material according to at least measurements of respective volumes of the material associated with the at least some of the pickup events.

34. The method of claim 32 or 33, wherein causing the at least one computing device to associate the measurements of the at least one property with the one or more respective portions of the material comprises causing the at least one computing device to associate the measurements of the at least one property with the one or more respective portions of the material according to at least measurements of height of the material in the at least one collection device.

35. The method of claim 31, 32, 33 or 34, wherein the at least one collection device comprises a hopper.

36. The method of any one of claims 31 to 35, wherein the at least one collection device comprises a breaker.

37. The method of any one of claims 31 to 36, wherein the at least one collection device comprises a silo.

38. The method of any one of claims 1 to 37, wherein the material comprises coal.

39. The method of any one of claims 1 to 38, wherein the material comprises at least one mineral.

40. The method of any one of claims 1 to 39, wherein the material comprises metal.

41. A system for facilitating movement of material from at least one stockpile comprising the material, the system comprising:
at least one computing device comprising:
at least one processor; and
at least one memory storing processor-executable instructions that, when executed by the at least one processor, cause the at least one computing device to, at least:
receive at least one pickup signal indicating at least a plurality of pickup events, each pickup event of the plurality of pickup events associated with a respective portion of the material; and
in response to at least the at least one pickup signal, identify at least respective locations of the pickup events.

42. The system of claim 41, wherein the processor-executable instructions, when executed by the at least one processor, further cause the at least one computing device to, at least, identify at least a respective pickup face of one or more stockpiles of the at least one stockpile of the material in response to, at least, at least some of the locations of the pickup events.

43. The system of claim 42, wherein the processor-executable instructions, when executed by the at least one processor, further cause the at least one computing device to, at least, segment the respective pickup face of each stockpile of the one or more stockpiles into a respective plurality of zones.

44. The system of claim 42, wherein the processor-executable instructions, when executed by the at least one processor, further cause the at least one computing device to, at least, segment each stockpile of the one or more stockpiles into a respective plurality of zones.

45. The system of claim 41, wherein the processor-executable instructions, when executed by the at least one processor, further cause the at least one computing device to, at least, segment each stockpile of one or more stockpiles of the at least one stockpile into a respective plurality of zones.

46. The system of any one of claims 41 to 45, wherein the processor-executable instructions, when executed by the at least one processor, further cause the at least one computing device to, at least, receive at least one material-property signal indicating at least one property of the respective portions of the material associated with at least some of the pickup events

47. The system of any one of claims 41 to 45, further comprising at least one analyzer operable to measure at least one property of the respective portions of the material associated with at least some of the pickup events.

48. The system of any one of claims 41 to 45, further comprising at least one analyzer comprising:
at least one analyzer processor;
at least one analyzer sensor; and
at least one analyzer memory storing analyzer processor-executable instructions that, when executed by the at least one analyzer processor, cause the at least one analyzer to, at least:
cause the at least one analyzer sensor to measure at least one property of the respective portions of the material associated with at least some of the pickup events.

49. The system of claim 46, 47, or 48, wherein the at least one property comprises measured quantities of at least one constituent of the respective portions of the material associated with the at least some of the pickup events.

50. The system of claim 49, wherein the at least one constituent comprises ash.

51. The system of claim 49 or 50, wherein the at least one constituent comprises calcium.

52. The system of claim 49, 50, or 51, wherein the at least one constituent comprises sulfur.

53. The system of any one of claims 46 to 52, wherein the processor-executable instructions, when executed by the at least one processor, further cause the at least one computing device to, at least, in response to at least measurement of the at least one property of the respective portions of the material associated with the at least some of the pickup events, associate respective estimations of the at least one property with respective regions of a plurality of regions of the material.

54. The system of claim 53, wherein at least some of the regions of the plurality of regions are respective ones of the at least one stockpile.

55. The system of claim 53 or 54, when dependent from claim 43, 44, or 45, wherein at least some of the regions of the plurality of regions are respective ones of the zones.

56. The system of claim 53, 54, or 55, wherein the processor-executable instructions, when executed by the at least one processor, further cause the at least one computing device to, at least, in response to at least associating the respective estimations of the at least one property with the respective regions, identify at least one respective location of at least one future pickup event.

57. The system of claim 56, wherein the at least one respective location of the at least one future pickup event comprises at least one respective region of the plurality of regions.

58. The system of claim 56 or 57, wherein causing the at least one computing device to identify the at least one respective location of the at least one future pickup event comprises causing the at least one computing device to identify the at least one respective location of the at least one future pickup event in response to at least one objective for a product comprising the respective portions of the material associated with the plurality of pickup events.

59. The system of claim 58, wherein the at least one objective for the product comprises minimizing a variability of a constituent of the product over time.

60. The system of claim 58, wherein the at least one objective for the product comprises minimizing a variability of relative ash content of the product over time.

61. The system of any one of claims 58 to 60, wherein the at least one objective for the product comprises obtaining a target calorific level of the product.

62. The system of any one of claims 58 to 61, wherein the at least one objective for the product comprises ensuring minimal deviation from a target level of ash content of the product.

63. The system of any one of claims 56 to 62, wherein the processor-executable instructions, when executed by the at least one processor, further cause the at least one computing device to, at least, in response to at least identifying the at least one respective location of the at least one future pickup event, transmit at least one future-pickup-location signal indicating at least the at least one respective location of the at least one future pickup event.

64. The system of claim 63, wherein causing the at least one computing device to transmit the at least one future-pickup-location signal comprises causing the at least one computing device to transmit the at least one future-pickup-location signal immediately after identifying the at least one respective location of the at least one future pickup event.

65. The system of claim 63 or 64, further comprising:
at least one material handler comprising:
at least one handler processor; and
at least one handler memory storing handler processor-executable instructions that, when executed by the at least one handler processor, cause the at least one material handler to, at least:
in response to at least the at least one future-pickup-location signal, operate according to the at least one respective location of the at least one future pickup event.

66. The system of claim 65, wherein causing the at least one material handler to operate according to the at least one respective location of the at least one future pickup event comprises causing the at least one material handler to move to the at least one respective location of the at least one future pickup event.

67. The system of claim 66, wherein the handler processor-executable instructions further comprise handler processor-executable instructions that, when executed by the at least one processor, further cause the at least one material handler to, at least, in response to moving to the at least one respective location of the at least one future pickup event, pick up at least one future portion of the material at the at least one respective location of the at least one future pickup event.

68. The system of claim 67, wherein the handler processor-executable instructions further comprise handler processor-executable instructions that, when executed by the at least one processor, further cause the at least one material handler to, at least, in response to picking up the at least one future portion of the material, transmit at least one future pickup signal indicating at least the at least one future pickup event associated with the at least one future portion of the material.

69. The system of any one of claims 65 to 68, wherein causing the at least one material handler to operate according to the at least one respective location of the at least one future pickup event comprises causing the at least one material handler to present the at least one respective location of the at least one future pickup event.

70. The system of any one of claims 46 to 69, wherein the processor-executable instructions, when executed by the at least one processor, further cause the at least one computing device to, at least, associate measurements of the at least one property with the respective portions of the material associated with the at least some of the pickup events.

71. The system of any one of claims 46 to 70, wherein the processor-executable instructions, when executed by the at least one processor, further cause the at least one computing device to, at least, in response to at least respective deposits, in at least one deposit location, of the respective portions of the material associated with the at least some of the pickup events, obtain information indicative of at least the respective deposits.

72. The system of claim 71, further comprising:
at least one collection device positioned to receive, from the at least one deposit location, the respective portions of the material associated with the at least some of the pickup events,
wherein the processor-executable instructions, when executed by the at least one processor, cause the at least one computing device to, in response to at least the information indicative of at least the respective deposits, estimate movement, of the respective portions of the material associated with the at least some of the pickup events, within the at least one collection device.

73. The system of claim 72, when dependent from claim 70, wherein causing the at least one computing device to associate the measurements of the at least one property with the one or more respective portions of the material comprises causing the at least one computing device to associate the measurements of the at least one property with the one or more respective portions of the material according to at least the estimated movement, of the respective portions of the material associated with the at least some of the pickup events, within the at least one collection device.

74. The system of claim 73, further comprising:
at least one volume sensor operable to sense respective volumes of the material associated with the at least some of the pickup events,
wherein causing the at least one computing device to associate the measurements of the at least one property with the one or more respective portions of the material comprises causing the at least one computing device to associate the measurements of the at least one property with the one or more respective portions of the material according to at least measurements, by the at least one volume sensor, of the respective volumes of the material associated with the at least some of the pickup events.

75. The system of claim 73 or 74, further comprising:
at least one height sensor operable to sense height of the material in the at least one collection device,
wherein causing the at least one computing device to associate the measurements of the at least one property with the one or more respective portions of the material comprises causing the at least one computing device to associate the measurements of the at least one property with the one or more respective portions of the material according to at least measurements, by the at least one height sensor, of height of the material in the at least one collection device.

76. The system of claim 72, 73, 74, or 75, wherein the at least one collection device comprises at least one hopper.

77. The system of any one of claims 72 to 76, wherein the at least one collection device comprises at least one breaker.

78. The system of any one of claims 72 to 77, wherein the at least one collection device comprises at least one silo.

79. The system of any one of claims 41 to 78, wherein the material comprises coal.

80. The system of any one of claims 41 to 79, wherein the material comprises at least one mineral.

81. The system of any one of claims 41 to 80, wherein the material comprises metal.
